(19) United States
(12) Patent Application Publication
(10) Pub. No.: US 2024/0184441 A1
(43) Pub. Date: Jun. 6, 2024

(54) Systems and Methods for Providing Continuous-Path and Delete Key Gestures at a Touch-Sensitive Keyboard

(71) Applicant: Apple Inc., Cupertino, CA (US)

(72) Inventors: Patrick W. Demasco, San Francisco, CA (US); Christopher P. Willmore, San Francisco, CA (US); James Magahern, San Francisco, CA (US); Justin S. Hogg, Mountain View, CA (US); Karl K. Hong, Fremont, CA (US); Matan Stauber, San Francisco, CA (US); Lee S. Broughton, Santa Cruz, CA (US); Julian K. Missig, Burlingame, CA (US)

(21) Appl. No.: 18/429,285

(22) Filed: Jan. 31, 2024

Related U.S. Application Data
(63) Continuation of application No. 16/586,836, filed on Sep. 27, 2019.
(60) Provisional application No. 62/844,053, filed on May 6, 2019.

(51) Int. Cl. G06F 3/04883; G06F 3/0484

(52) U.S. Cl. CPC G06F 3/04883; G06F 3/0484

(57) ABSTRACT

Systems and methods for responding to continuous-path gestures are disclosed. An example method includes: displaying a plurality of keys on a touch-sensitive keyboard; and in response to a continuous-path gesture on the touch-sensitive keyboard in which a contact associated with the continuous-path gesture travels over two or more of the plurality of keys: begin displaying a punctuation symbol key on the touch-sensitive keyboard; and displaying one or more characters based on keys contacted by the contact during the continuous-path gesture.

### RELATED APPLICATIONS

This is a continuation of U.S. patent application Ser. No. 16/586,836, filed Sep. 27, 2019, which claims priority to U.S. Provisional Application Ser. No. 62/844,053, filed May 6, 2019, which are incorporated by reference herein in their entireties.

### TECHNICAL FIELD

The embodiments herein generally relate to electronic devices with touch-sensitive displays and, more specifically, to systems and methods for responding to continuous-path and delete key gestures at a touch-sensitive keyboard.

### BACKGROUND

Handheld electronic devices with touch-sensitive displays often include interfaces that allow users to type at an onscreen touch-sensitive keyboard instead of having to carry around and connect an external, physical keyboard. The touch-sensitive keyboard on these displays often do not include punctuation symbol keys because the punctuation symbol keys are typically buried under other keys. As such, users often need to waste time locating punctuation symbol keys. This is especially problematic during a continuous-path gesture in which a contact input does not lift off from the touch-sensitive keyboard while the user creates a string of characters to input into a text-input area. Another problem with touch-sensitive keyboards is that users must tap on or press and hold a touch-sensitive delete key to delete characters from a text-input area. Thus, users often waste time using the delete key because the tap and press-and-hold gestures delete one character at a time.

### SUMMARY

Accordingly, there is a need for electronic devices with more efficient methods and interfaces for responding to continuous-path and delete key gestures at a touch-sensitive keyboard. Such methods and interfaces optionally complement or replace conventional methods for responding to continuous-path and delete key gestures at a touch-sensitive keyboard. Such methods and interfaces improve typing efficiency. Through such improvements, such methods and interfaces help to enhance the operability of the electronic device and make the human-machine interface more efficient (e.g., by allowing the user to type punctuation symbols during a continuous-path gesture without having to tap the function key and search for the desired punctuation symbol, and to quickly and seamlessly delete strings of characters without having to tap multiple times on the delete key, or press-and-hold the delete key for a prolonged duration) which, additionally, reduces power usage and improves battery life of the device by enabling the user to spend less time using the touch-sensitive keyboard.

The above deficiencies and other problems associated with user interfaces for electronic devices with touch-sensitive surfaces are reduced or eliminated by the devices disclosed herein. In some embodiments, the device is a desktop computer. In some embodiments, the device is portable (e.g., a notebook computer, tablet computer, or handheld device). In some embodiments, the device has a touchpad. In some embodiments, the device has a touch-sensitive display (also known as a “touch screen” or “touch-screen display”). In some embodiments, the device has a graphical user interface (GUI), one or more processors, memory and one or more modules, programs or sets of instructions stored in the memory for performing multiple functions. In some embodiments, the user interacts with the GUI primarily through stylus and/or finger contacts and gestures on the touch-sensitive surface. In some embodiments, the functions optionally include image editing, drawing, presenting, word processing, website creating, disk authoring, spreadsheet making, game playing, telephoning, video conferencing, e-mailing, instant messaging, workout support, digital photography, digital video, web browsing, and digital music. Executable instructions for performing these functions are, optionally, included in a non-transitory computer-readable storage medium or other computer program product configured for execution by one or more processors.

(A1) In accordance with some embodiments, a method of responding to different gestures on a touch-sensitive delete key is performed at an electronic device (e.g., portable multifunction device 100, FIG. 1A) that includes a display (e.g., touch-sensitive display 112, FIG. 1A) and a touch-sensitive delete key (e.g., touch-sensitive delete key 418, FIG. 4B). The method includes: displaying a series of characters and a cursor after a last character of the series of characters in a text-input area on the display. The method further includes: in response to a tap gesture on the touch-sensitive delete key, deleting the last character of the series of characters from the text-input area and continuing to display a remainder of the series of characters in the text-input area. The method further includes: in response to a swipe gesture on the touch-sensitive delete key, deleting the remainder of the series of characters from the text-input area. Users often need to waste time separately deleting characters one at a time. Allowing a user to tap or swipe on the delete key to perform a delete function on a series of characters enhances the operability of the device and makes the human-machine interface more efficient (e.g., by allowing the user to quickly and seamlessly delete strings of characters without having to tap multiple times on the delete key, or press-and-hold the delete key for a prolonged duration) which, additionally, reduces power usage and improves battery life of the device by enabling the user to spend less time using the delete key.

(A2) In some embodiments of the method of A1, after deleting the remainder of the series of characters from the text-input area, the device continues to display in the text-input area a second series of characters. In some embodiments, the method further includes: in response to a new swipe gesture on the touch-sensitive delete key, deleting the second series of characters from the text-input area. As noted above, users often need to waste time separately deleting characters one at a time. Allowing a user to swipe on the delete key to delete additional series of characters enhances the operability of the device and makes the human-machine interface more efficient (e.g., by allowing the user to quickly and seamlessly delete multiple strings of characters without having to tap on the delete key numerous times, or press-and-hold the delete key for a prolonged duration) which, additionally, reduces power usage and improves battery life of the device by enabling the user to spend less time using the delete key.

(A3) In some embodiments of the method of A2, the new swipe gesture is received within a predetermined amount of time after a lift-off of a contact associated with the swipe gesture, and the deleting the second series of characters includes deleting the second series of characters at a same time. Ensuring that the new swipe gesture is received within a predetermined amount of time allows users to quickly delete multiple different series of characters in full, without having to do any character-by-character deletion operations. Use of this predetermined amount of time thus helps to enhance the operability of the device and make the human-machine interface more efficient (e.g., by allowing the user to quickly and seamlessly delete strings of characters without having to tap or press and hold the delete key for a prolonged duration) which, additionally, reduces power usage and improves battery life of the device by enabling the user to spend less time using the delete key.

(A4) In some embodiments of the method of A3, after deleting the second series of characters, the device continues to display a third series of characters in the text-input area. In some embodiments, the method further includes: in response to an additional swipe gesture on the touch-sensitive delete key that is received after the predetermined amount of time from a lift-off of a contact associated with the new swipe gesture, deleting one character of the third series of characters from the text-input area before deleting a remainder of the third series of characters from the text-input area. If a swipe gesture over the delete key is received after the predetermined amount of time, then the delete operation first deletes a character on the key-down event, followed by deleting a remainder of the series of characters. In this ways, users are ensured of a consistent user experience in which key-down events cause character deletion, unless a swipe gesture is received shortly thereafter. This helps to enable sustained interactions with the device that are consistent with users' expectations for how those devices will operate.

(A5) In some embodiments of the method of A2, before deleting the second series of characters, the method further includes: displaying a visual indicator around the second series of characters to provide an indication that the second series of characters would be deleted from the text-input area after a new swipe gesture on the touch-sensitive delete key. Users often do not know what characters they are about to delete before deleting those characters. Displaying a visual indicator around the second series of characters enhances the operability of the device and makes the human-machine interface more efficient (c.g., by providing improved feedback to the user such that the user knows what he/she will delete before performing a new swipe gesture) which, additionally, reduces power usage and improves battery life of the device by enabling the user to spend less time using the delete key, and to avoid having to back out undesired changes (e.g., deleting a word that was not intended to be deleted because the user was not alerted to how the next delete operation would occur).

(A6) In some embodiments of the method of any one of A1-A5, the method further includes: in response to a press-and-hold gesture on the touch-sensitive delete key, deleting two or more separate series of characters from the text-input area, wherein the two or more separate series of characters are deleted from the text-input area at different points in time.

(A7) In some embodiments of the method of any one of A1-A6, the series of characters and the second series of characters were added to the text-input area based on a continuous-path gesture in which a continuous contact moves across multiple keys of a touch-sensitive keyboard. Users often need to waste time pressing and lifting off keys when typing on a keyboard. Allowing a user to perform a continuous path gesture enhances the operability of the device and makes the human-machine interface more efficient (e.g., by allowing the user to quickly and seamlessly create strings of characters without having to lift an input off the keyboard) which, additionally, reduces power usage and improves battery life of the device by enabling the user to spend less time using the keyboard.

(A8) In some embodiments of the method of any one of A1-A7, the series of characters and the second series of characters were added to the text-input arca based on tap gestures over respective keys of a touch-sensitive keyboard.

(A9) In some embodiments of the method of any one of A1-A8, the touch-sensitive delete key is displayed on a touch-sensitive keyboard on the display. Users often need to waste time separately deleting characters one at a time. Allowing a user to tap or swipe on the delete key to perform a delete function on the same keyboard being used to type enhances the operability of the device and makes the human-machine interface more efficient (e.g., by allowing the user to quickly and seamlessly delete characters and strings of characters without having to tap or press and hold the delete key for a prolonged duration) which, additionally, reduces power usage and improves battery life of the device by enabling the user to spend less time using the delete key.

(A10) In some embodiments of the method of any one of A1-A9, the touch-sensitive delete key is displayed on a touch-sensitive secondary display that is separate from the display of the electronic device. Users of laptops or tablets often use keyboards that are not displayed on a touch-sensitive display. Allowing a user to access the touch-sensitive delete key on multiple displays enhances the operability of the device and makes the human-machine interface more efficient (e.g., by allowing the user to quickly and seamlessly use a preferred touch-sensitive display over another touch-sensitive display to delete characters and strings of characters) which, additionally, reduces power usage and improves battery life of the device by enabling the user to spend less time using the device.

(A11) In accordance with some embodiments, a non-transitory computer-readable storage medium is provided. In some embodiments, the non-transitory computer-readable storage medium stores executable instructions that, when executed by one or more processors of an electronic device with a display and a touch-sensitive delete key, cause the electronic device to perform the method of any one of A1-A10.

(A12) In accordance with some embodiments, an electronic device is provided. In some embodiments, the electronic device includes: one or more processors; a display; a touch-sensitive delete key; and memory storing one or more programs that are configured for execution by the one or more processors, the one or more programs including instructions for performing the method of any one of A1-A10.

(A13) In accordance with some embodiments, an electronic device with a display and a touch-sensitive delete key is provided. In some embodiments, the electronic device includes: means for performing the method of any one of A1-A10.

(A14) In accordance with some embodiments, an information processing apparatus for use in an electronic device includes a display and a touch-sensitive delete key, the information processing apparatus including: means for performing the method of any one of A1-A10.

(A15) In accordance with some embodiments, a graphical user interface for an electronic device with one or more processors, memory, display, and a touch-sensitive delete key is provided. In some embodiments, the one or more processors execute one or more programs stored in the memory. In some embodiments, the graphical user interface comprising user interfaces displayed in accordance with any one of the methods of A1-A10.

(A16) In accordance with some embodiments, a non-transitory computer-readable storage medium is provided. In some embodiments, non-transitory computer-readable storage medium stores executable instructions that, when executed by one or more processors of an electronic device with a display and a touch-sensitive delete key, cause the electronic device to display a series of characters and a cursor after a last character of the series of characters in a text-input area on the display. In some embodiments, the instructions further cause the electronic device to detect a gesture on the touch-sensitive delete key. In some embodiments, the instructions further cause the electronic device to determine whether the gesture is of a first gesture type or a second gesture type different from the first gesture type. In some embodiments, the instructions further cause the electronic device to upon determining that the gesture is of the first gesture type, perform a first delete function on at least one of the series of characters adjacent the cursor. In some embodiments, the instructions further cause the electronic device to upon determining that the gesture is of the second gesture type, perform a second delete function on at least one of the series of characters adjacent the cursor, wherein the second delete function is different than the first delete function. Users often need to waste time separately deleting characters one at a time. Allowing a user to perform a first or second delete gesture on the delete key to perform two different delete functions enhances the operability of the device and makes the human-machine interface more efficient (e.g., by allowing the user to quickly and seamlessly delete characters and strings of characters without having to tap or press and hold the delete key for a prolonged duration) which, additionally, reduces power usage and improves battery life of the device by enabling the user to spend less time using the delete key.

(B1) In accordance with some embodiments, a method of adding a punctuation symbol key to a touch-sensitive keyboard is performed at an electronic device (e.g., portable multifunction device 100, FIG. 1A) that includes a display (e.g., touch-sensitive display 112, FIG. 1A) and a touch-sensitive keyboard (e.g., touch-sensitive keyboard 314, FIG. 3E). The method includes: displaying a plurality of keys on the touch-sensitive keyboard. The method further includes: in response to a continuous-path gesture on the touch-sensitive keyboard in which a contact associated with the continuous-path gesture travels over two or more of the plurality of keys: begin displaying a punctuation symbol key on the touch-sensitive keyboard. The method further includes: displaying, in a text-input area on the display, one or more characters based on respective keys contacted by the contact during the continuous-path gesture. Users often need to waste time locating punctuation symbol keys, as they are typically buried under function keys or cannot be activated during a continuous-path gesture. Allowing a user to access punctuation symbol keys during a continuous-path gesture enhances the operability of the device and makes the human-machine interface more efficient (e.g., by allowing the user to quickly and seamlessly type punctuation symbols during a continuous-path gesture without having to tap the function key and search for the desired punctuation symbol) which, additionally, reduces power usage and improves battery life of the device by enabling the user to spend less time using the touch-sensitive keyboard.

(B2) In some embodiments of the method of B1, the displaying of the punctuation symbol key includes ceasing to display a respective key of the plurality of keys on the touch-sensitive keyboard. Users often need to waste time locating punctuation symbol keys, as they are typically buried under function keys or cannot be activated during a continuous-path gesture. Ceasing to display a respective key allows the device to make room to display a punctuation symbol on the touch-sensitive keyboard during a continuous-path gesture, thus enhancing the operability of the device and making the human-machine interface more efficient (e.g., by allowing the user to quickly and seamlessly type punctuation symbols during a continuous-path gesture without having to tap the function key and search for the desired punctuation symbol) which, additionally, reduces power usage and improves battery life of the device by enabling the user to spend less time using the touch-sensitive keyboard.

(B3) In some embodiments of the method of B2, the displaying of the punctuation symbol key includes displaying an additional punctuation symbol key on the touch-sensitive keyboard, and the punctuation symbol key and the additional punctuation symbol key are displayed in an area of the touch-sensitive keyboard that was previously used to display the respective key of the plurality of keys. Users often need to waste time locating punctuation symbol keys, as they are typically buried under function keys or cannot be activated during a continuous-path gesture. Displaying punctuation symbol keys during a continuous-path gesture in an area of the touch-sensitive keyboard that was previously used to display the respective key of the plurality of keys enhances the operability of the device and makes the human-machine interface more efficient (e.g., by allowing the user to quickly and seamlessly type punctuation symbols during a continuous-path gesture without having to tap the function key and search for the desired punctuation symbol) which, additionally, reduces power usage and improves battery life of the device by enabling the user to spend less time using the touch-sensitive keyboard.

(B4) In some embodiments of the method of B3 an arrangement of the punctuation symbol key and the additional punctuation key is determined based on whether the continuous path gesture is provided using a user's left or right hand. Users often need to use both hands when using a touch-sensitive keyboard because certain keys are too far away from the finger they use to type with. Displaying certain punctuation symbol keys during a continuous-path gesture closer to the finger the users use to type with enhances the operability of the device and makes the human-machine interface more efficient (e.g., by allowing the user to quickly and seamlessly type punctuation symbols during a continuous-path gesture without having to use both hands) which, additionally, reduces power usage and improves battery life of the device by enabling the user to spend less time using the touch-sensitive keyboard.

(B5) In some embodiments of the method of B3 the respective key of the plurality of keys is a function key that, when selected, causes display of additional functionality associated with the touch-sensitive keyboard. Users often need to waste time locating punctuation symbol keys, as they are typically buried under function keys or cannot be activated during a continuous-path gesture. Allowing a user to access punctuation symbol keys during a continuous-path gesture enhances the operability of the device and makes the human-machine interface more efficient (e.g., by allowing the user to quickly and seamlessly type punctuation symbols during a continuous-path gesture without having to tap the function key and search for the desired punctuation symbol) which, additionally, reduces power usage and improves battery life of the device by enabling the user to spend less time using the touch-sensitive keyboard.

(B6) In some embodiments of the method of B4, the method further includes: after the contact associated with the continuous-path gesture has lifted off from the touch-sensitive display, begin displaying the function key and cease to display the punctuation symbol key. Users often need to waste time exiting a continuous-path gesture mode to locate function keys that were replaced with punctuation keys. Allowing a user to lift off from the touch-sensitive display to access function keys that were hidden during the continuous-path gesture enhances the operability of the device and makes the human-machine interface more efficient (e.g., by allowing the user to quickly and seamlessly navigate between a touch-sensitive keyboard mode that displays a punctuation symbol key and a mode that displays a function key) which, additionally, reduces power usage and improves battery life of the device by enabling the user to spend less time using the touch-sensitive keyboard.

(B7) In some embodiments of the method of any one of B1-B6, the method further includes: after the displaying of the punctuation symbol key: in response to the contact associated with the continuous-path gesture travelling over the punctuation symbol key, displaying, in the text-input area on the display, a punctuation symbol associated with the punctuation symbol key. Users often need to waste time locating punctuation symbol keys, as they are typically buried under function keys or cannot be activated during a continuous-path gesture. Allowing a user to access punctuation symbol keys during a continuous-path gesture enhances the operability of the device and makes the human-machine interface more efficient (e.g., by allowing the user to quickly and seamlessly type punctuation symbols during a continuous-path gesture without having to tap the function key and search for the desired punctuation symbol) which, additionally, reduces power usage and improves battery life of the device by enabling the user to spend less time using the touch-sensitive keyboard.

(B8) In some embodiments of the method of B7, displaying the punctuation symbol in the text-input area includes displaying, automatically without human intervention, a whitespace character adjacent to the punctuation symbol in the text-input area. Users often incorrectly type a character immediately after typing a punctuation symbol, requiring users to manually correct the mistake by deleting text and/or moving the cursor back to the location of the mistake. Automatically displaying a whitespace character adjacent to a typed punctuation symbol enhances the operability of the device and makes the human-machine interface more efficient (e.g., by preventing the user from having to manually correct a mistakenly typed character adjacent to a punctuation symbol) which, additionally, reduces power usage and improves battery life of the device by enabling the user to spend less time using the touch-sensitive keyboard.

(B9) In some embodiments of the method of any one of B1-B8, the method further includes: during the continuous-path gesture, displaying two or more selectable word-completion options based on characters over which the contact associated with the continuous-path gesture has travelled. Users often need to waste time typing every character in a word. Allowing a user to select a word-completion option based on characters that have already been displayed in the text-input area enhances the operability of the device and makes the human-machine interface more efficient (e.g., by allowing the user to quickly and seamlessly complete a word without having to type every character of the word) which, additionally, reduces power usage and improves battery life of the device by enabling the user to spend less time using the touch-sensitive keyboard.

(B10) In some embodiments of the method of B9, the two or more selectable word-completion options displayed during the continuous-path gesture are displayed directly above the touch-sensitive keyboard on the display. Users often need to waste time typing every character in a word. Allowing a user to select a word-completion option based on characters that have already been displayed in the text-input area enhances the operability of the device and makes the human-machine interface more efficient (e.g., by allowing the user to quickly and seamlessly complete a word without having to type every character of the word) which, additionally, reduces power usage and improves battery life of the device by enabling the user to spend less time using the touch-sensitive keyboard.

(B11) In some embodiments of the method of B9, the two or more word-completion options displayed during the continuous-path gesture are displayed in the text-input arca. Word-completion options are often displayed in an area of a touch-sensitive display separate from the touch-sensitive keyboard and the text-input area. Displaying the word-completion options in-line with characters displayed in the text-input area enhances the operability of the device (e.g., by reducing clutter on the touch-sensitive display).

(B12) In some embodiments of the method of any one of B1-B11, the method further includes: while the contact associated with the continuous-path gesture travels across the touch-sensitive keyboard, displaying a visual indicator reflecting a path followed by the continuous-path gesture, the path indicating a predetermined number of keys over which the continuous-path gesture has travelled. Users often only have one way of knowing which characters they previously typed, i.e., the characters that are displayed in a text-input arca. Displaying a visual indicator reflecting a path followed by the continuous-path gesture enhances the operability of the device (e.g., by providing users with an additional indication of the characters previously typed).

(B13) In some embodiments of the method of B12, the indicator has a greatest line width closer to the contact associated with the continuous-path gesture and a gradually decreasing line width farther away from the contact. Users often only have one way of knowing which characters they previously typed, i.e., the characters that are displayed in a text-input area. Displaying a visual indicator reflecting a path followed by the continuous-path gesture enhances the operability of the device (e.g., by providing users with an additional indication of the characters previously typed).

(B14) In accordance with some embodiments, a non-transitory computer-readable storage medium is provided. In some embodiments, non-transitory computer-readable readable storage medium stores executable instructions that, when executed by one or more processors of an electronic device with a display and a touch-sensitive keyboard, cause the electronic device to perform the method of any one of B1-B13.

(B15) In accordance with some embodiments, an electronic device is provided. In some embodiments, the electronic device includes: one or more processors; a display; a touch-sensitive keyboard; and memory storing one or more programs that are configured for execution by the one or more processors, the one or more programs including instructions for performing the method of any one of B1-B13.

(B16) In accordance with some embodiments, an electronic device with a display and a touch-sensitive keyboard is provided. In some embodiments, the electronic device includes: means for performing the method of any one of B1-B13.

(B17) In accordance with some embodiments, an information processing apparatus is provided for use in an electronic device that includes a display and a touch-sensitive sensitive keyboard. In some embodiments, the information processing apparatus includes: means for performing the method of any one of B1-B13.

(B18) In accordance with some embodiments, a graphical user interface for an electronic device with one or more processors, memory, display, and a touch-sensitive keyboard is provided. In some embodiments, the one or more processors execute one or more programs stored in the memory, the graphical user interface including user interfaces displayed in accordance with any one of the methods of B1-B13.

(C1) In accordance with some embodiments, a method of distinguishing between a tap gesture or a continuous-path gesture on a touch-sensitive keyboard is performed at an electronic device (e.g., portable multifunction device 100, FIG. 1A) that includes a display (e.g., touch-sensitive display 112, FIG. 1A) and a touch-sensitive keyboard (e.g., touch-sensitive keyboard 314, FIG. 3E). The method includes: receiving keyboard inputs at the touch-sensitive keyboard, and establish disambiguation criteria for distinguishing between a continuous-path gesture or a multiple-tap gesture based on one or more input characteristics of the received keyboard inputs. The method further includes: detecting a subsequent keyboard input and, in response, comparing the subsequent keyboard input to the disambiguation criteria. The method further includes: in accordance with a determination that the comparison with the disambiguation criteria indicates that the subsequent keyboard input is a continuous-path gesture, displaying an indication, over the touch-sensitive keyboard, of a path traveled by the subsequent keyboard input. The method further includes: in accordance with a determination that the comparison with the disambiguation criteria indicates that the subsequent keyboard input is a multiple-tap gesture, forgoing display of the indication of the path traveled by the subsequent keyboard input. Users often need to waste time exiting a continuous-path gesture mode to locate keys that may have been replaced in that mode. Allowing a user to either perform a continuous-path gesture or a multiple-tap gesture enhances the operability of the device and makes the human-machine interface more efficient (e.g., by allowing the user to quickly and seamlessly navigate between a continuous-path gesture mode and a multiple-tap gesture mode) which, additionally, reduces power usage and improves battery life of the device by enabling the user to spend less time using the device.

Thus, electronic devices with displays, touch-sensitive surfaces and optionally one or more sensors to detect intensity of contacts with the touch-sensitive surface are provided with more efficient methods and interfaces for performing continuous-path and delete key gesture at a touch-sensitive keyboard, thereby enhancing the operability of the device and making the human machine interface more efficient. Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Description of Embodiments section below, in conjunction with the following drawings in which like reference numerals refer to corresponding parts throughout the drawings.

FIG. 1A is a high-level block diagram of a computing device with a touch-sensitive display, in accordance with some embodiments.

FIG. 1B is a diagram used to illustrate exemplary components for event handling, in accordance with some embodiments.

FIG. 1C is a diagram used to illustrate a portable multifunction device having a touch-sensitive display, in accordance with some embodiments.

FIG. 1D is a diagram used to illustrate a user interface on a device with a touch-sensitive surface that is separate from a touch-sensitive display, in accordance with some embodiments.

FIG. 2 is a diagram used to illustrate a user interface for a menu of applications, in accordance with some embodiments.

FIG. 3A is a flowchart illustrating a method of responding to a continuous-path gesture at a touch-sensitive keyboard, in accordance with some embodiments.

FIGS. 3B-3D are diagrams of a user interface in which a continuous-path gesture can be performed, in accordance with some embodiments.

FIG. 4A is a flowchart illustrating a method of responding to a delete key gesture at a touch-sensitive keyboard, in accordance with some embodiments.

FIGS. 4B-4N are diagrams of a user interface in which a delete key gesture is performed, in accordance with some embodiments.

FIGS. 5A-5D are flowcharts illustrating methods of adding a punctuation symbol key to a touch-sensitive keyboard, in accordance with some embodiments.

FIGS. 6A-6C and 7 are flowcharts illustrating methods of responding to different gestures on a touch-sensitive delete key, in accordance with some embodiments.

FIG. 8 is a flowchart illustrating a method of distinguishing between a tap gesture or a continuous-path gesture on a touch-sensitive keyboard, in accordance with some embodiments.

### DESCRIPTION OF EMBODIMENTS

As discussed above and in more detail below, there is a need for electronic devices with more efficient methods and interfaces for responding to continuous-path and delete key gestures at a touch-sensitive keyboard. Disclosed herein are novel methods and interfaces to address these needs. Such methods and interfaces optionally complement or replace conventional methods for responding to continuous-path and delete key gestures at a touch-sensitive keyboard. Such methods and interfaces improve typing efficiency at touch-sensitive keyboards. Through such improvements, such methods and interfaces help to enhance the operability of the electronic device and make the human-machine interface more efficient (e.g., by allowing the user to type punctuation symbols during a continuous-path gesture without having to tap the function key and search for the desired punctuation symbol, and to quickly and seamlessly delete strings of characters without having to tap multiple times on the delete key, or press-and-hold the delete key for a prolonged duration) which, additionally, reduces power usage and improves battery life of the device by enabling the user to spend less time using the touch-sensitive keyboard.

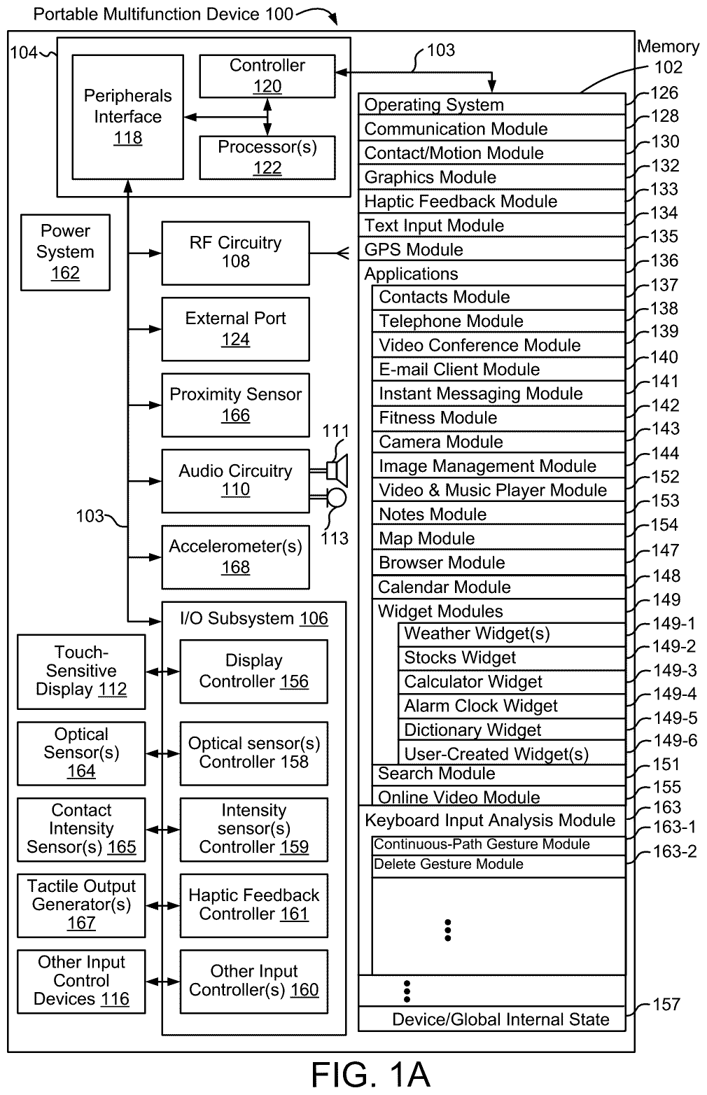

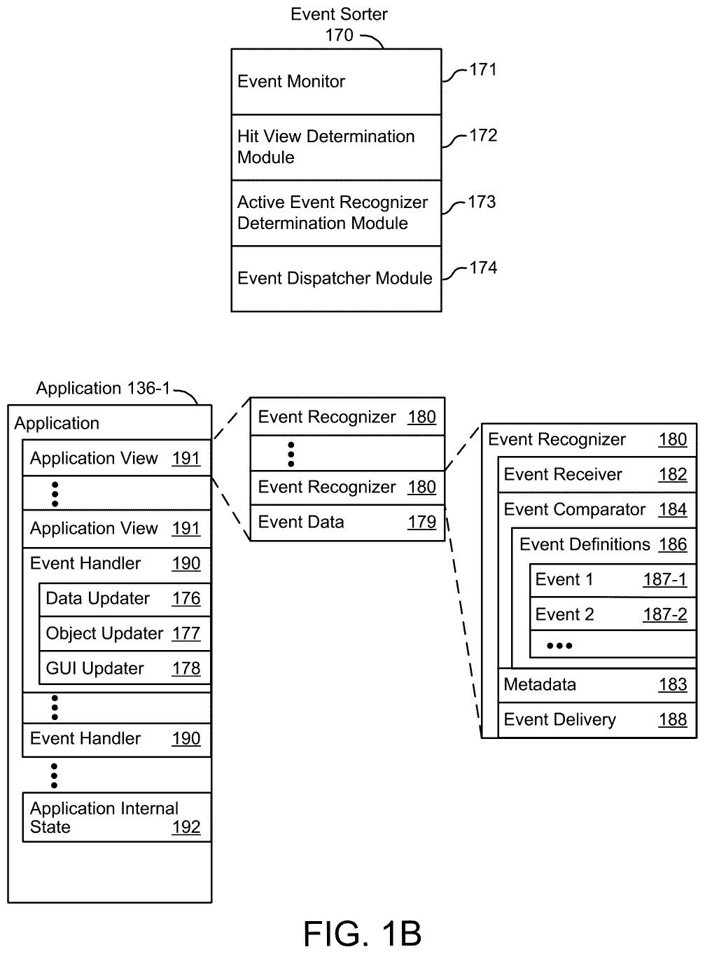

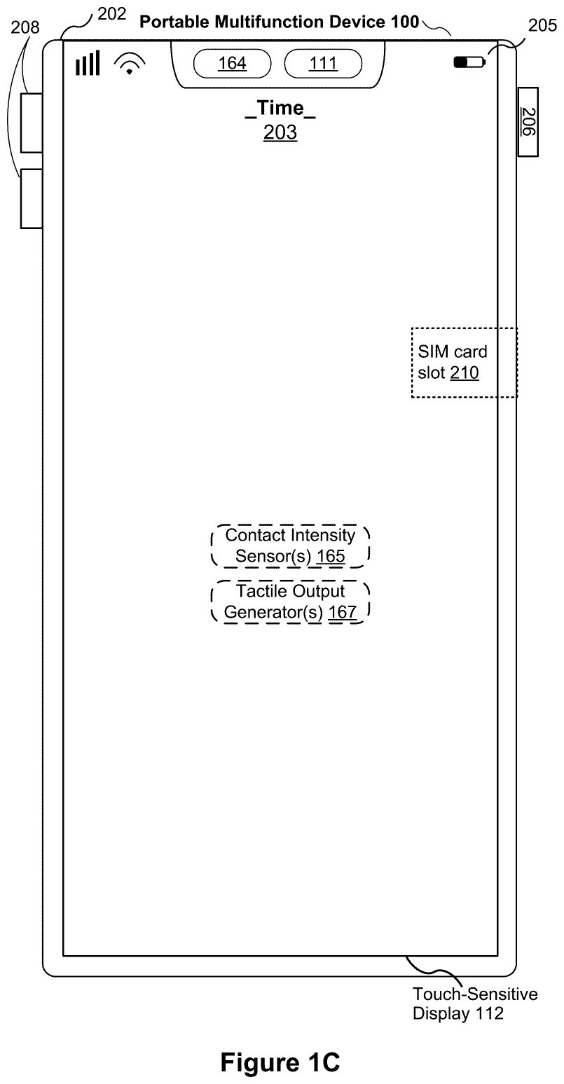

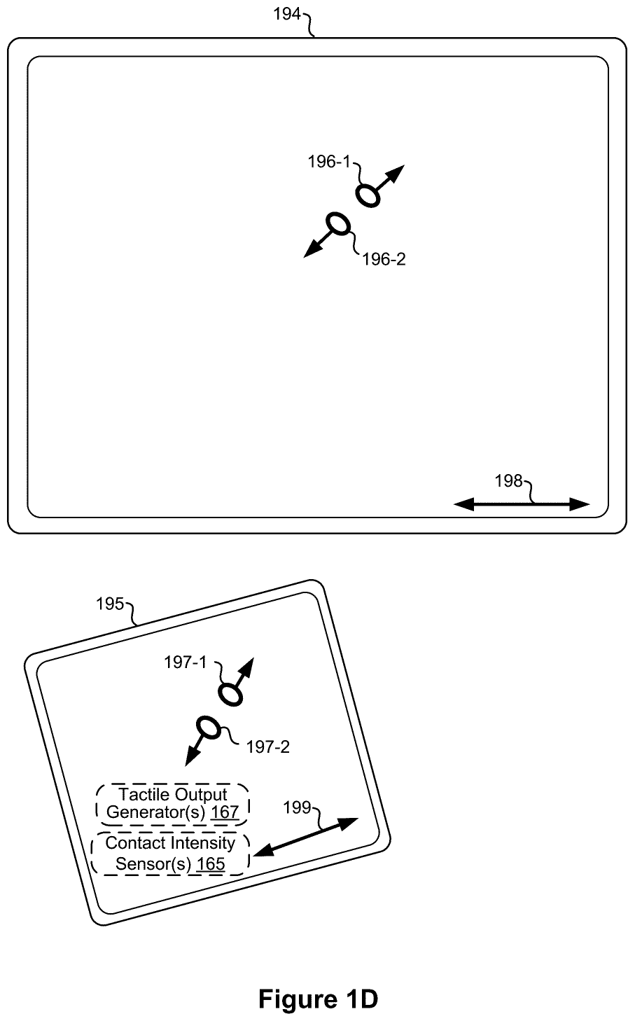

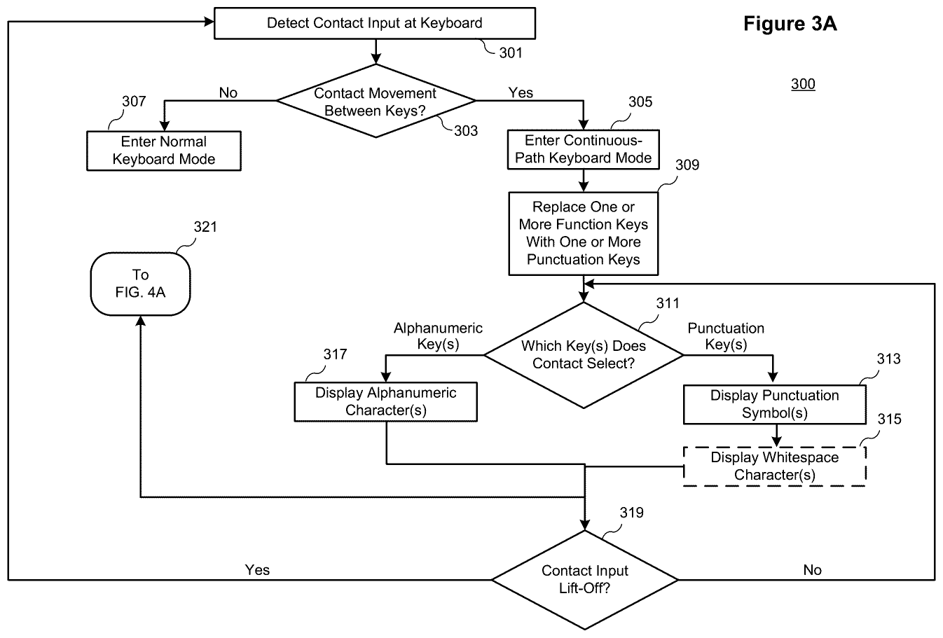

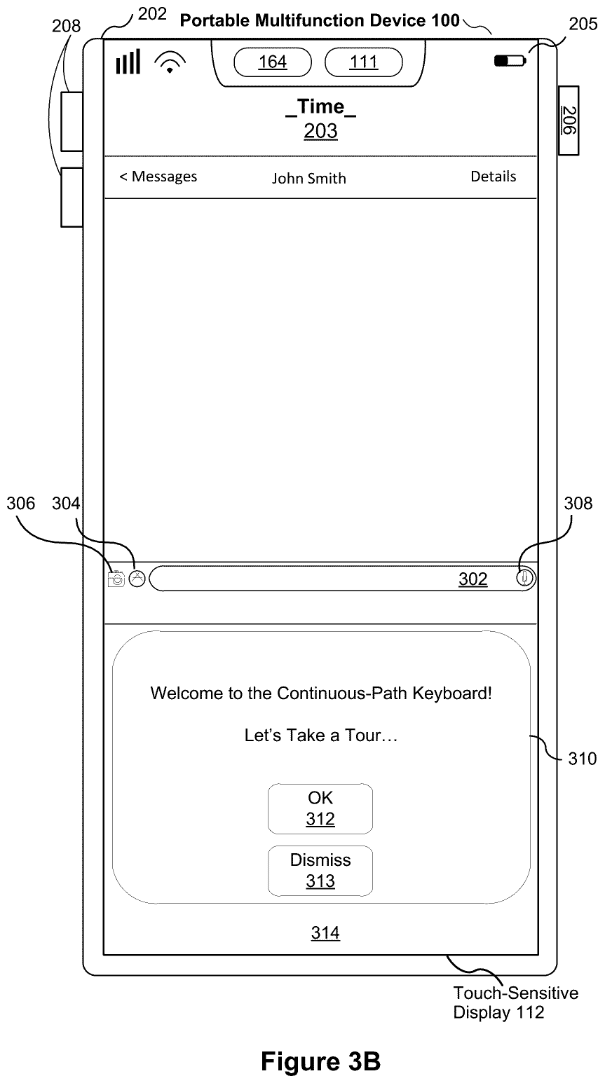

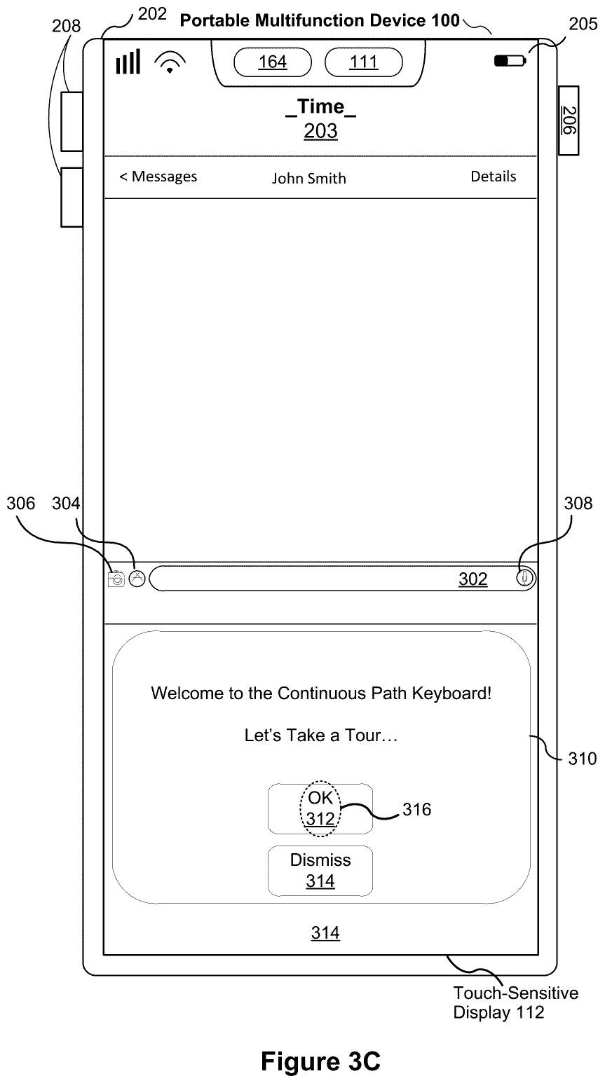

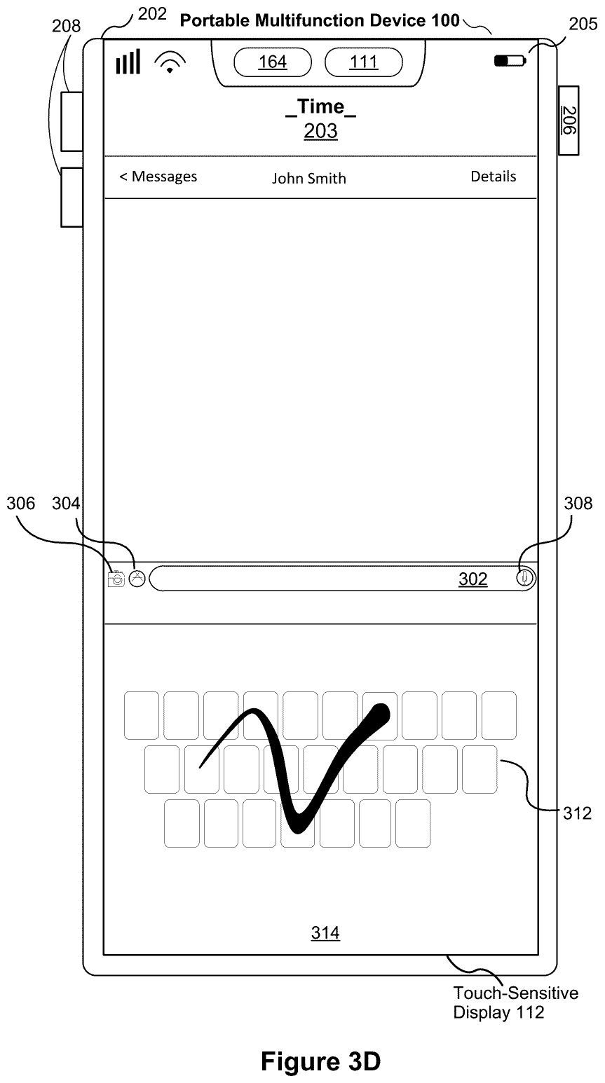

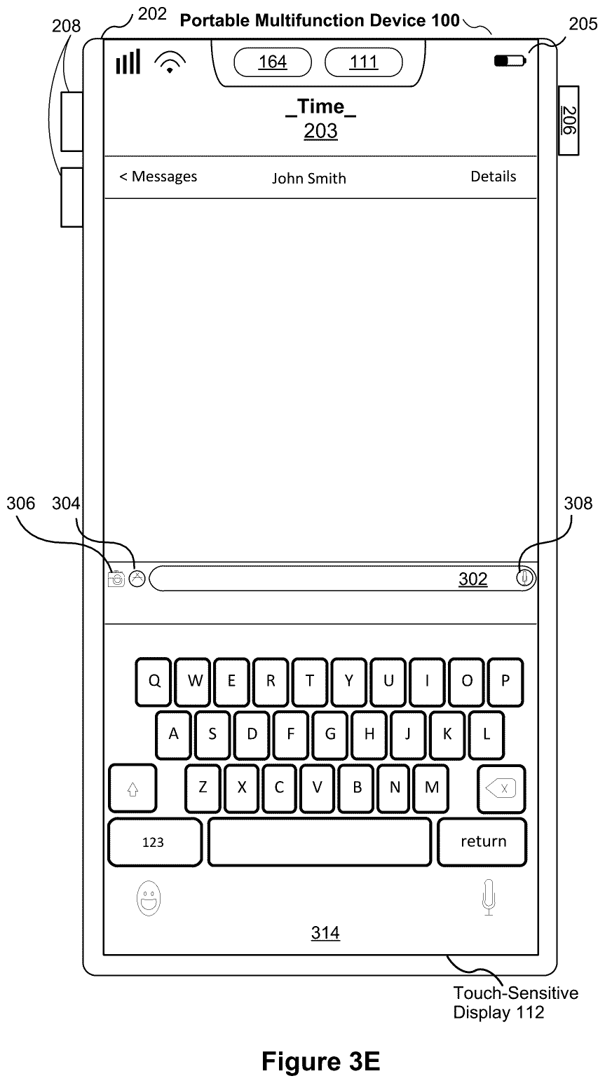

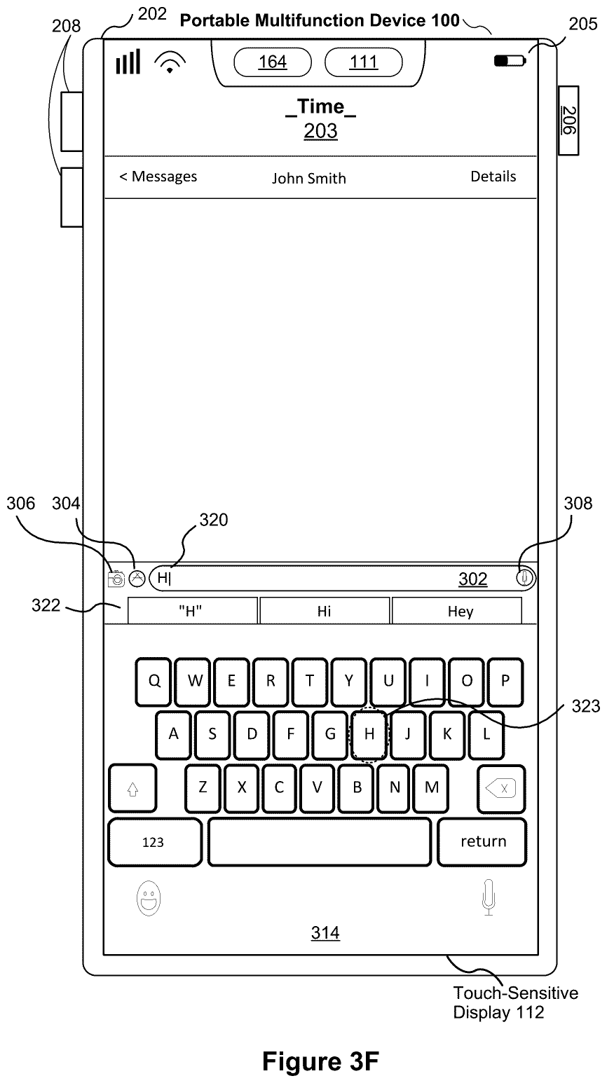

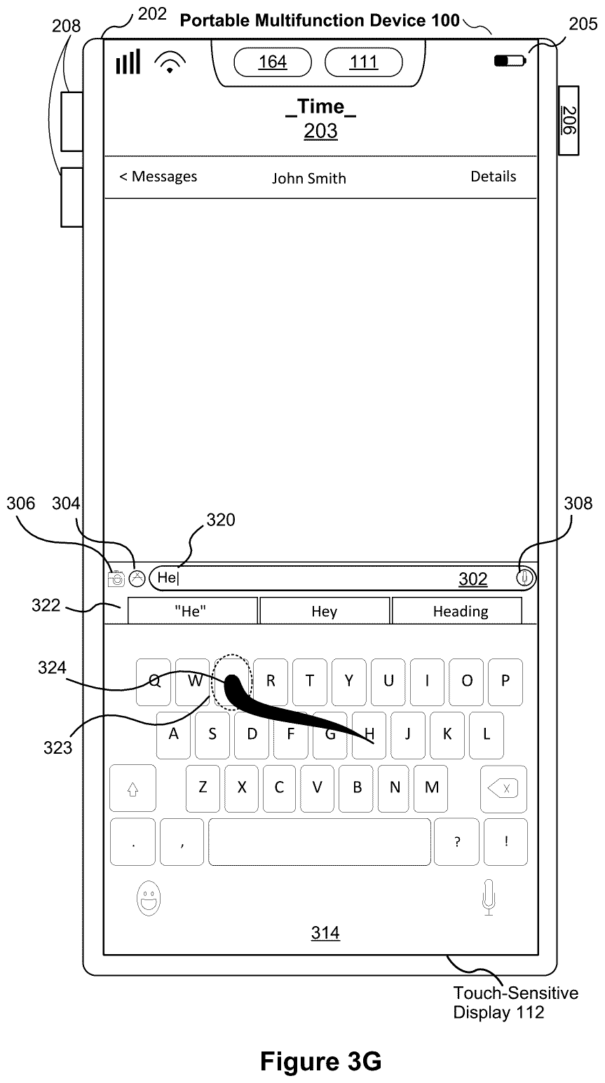

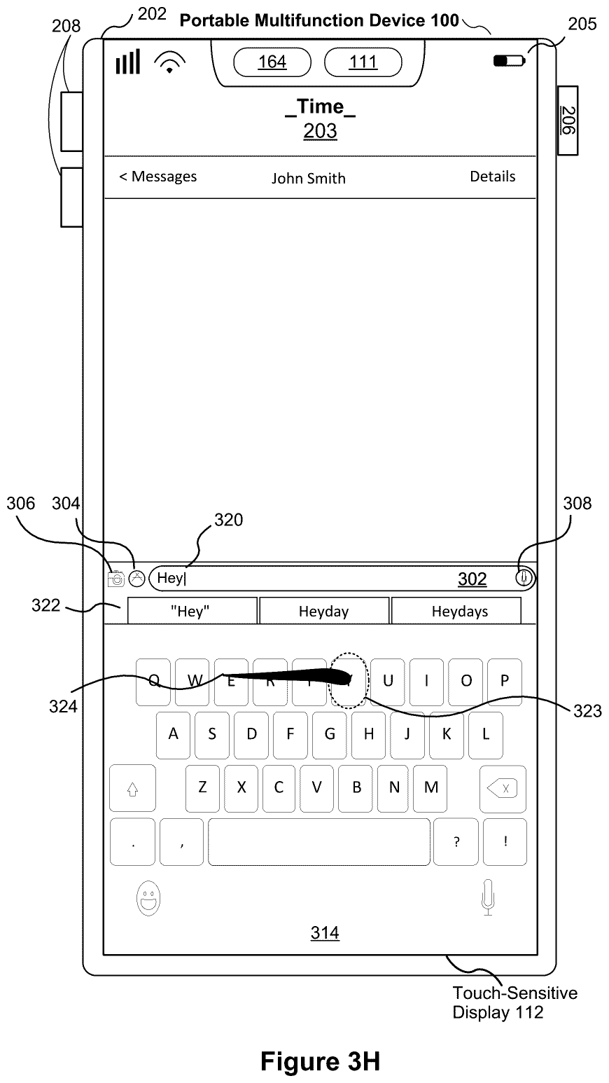

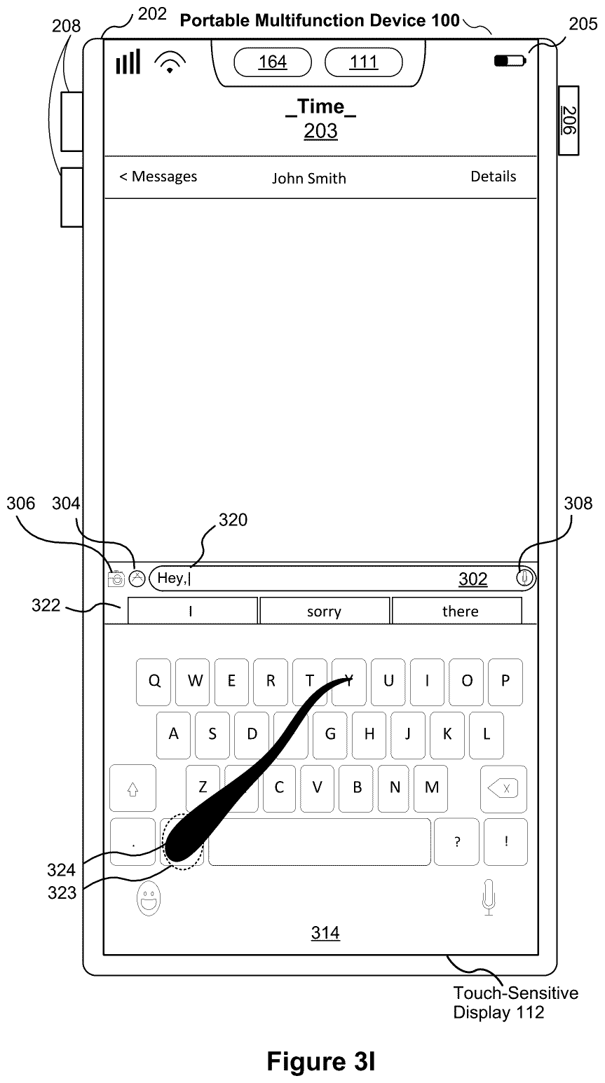

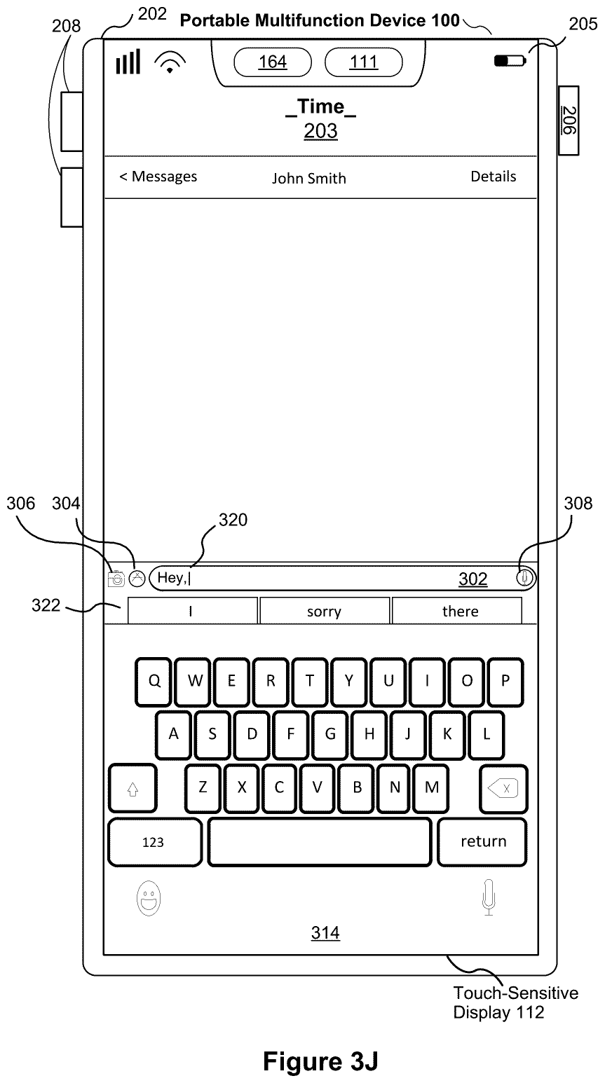

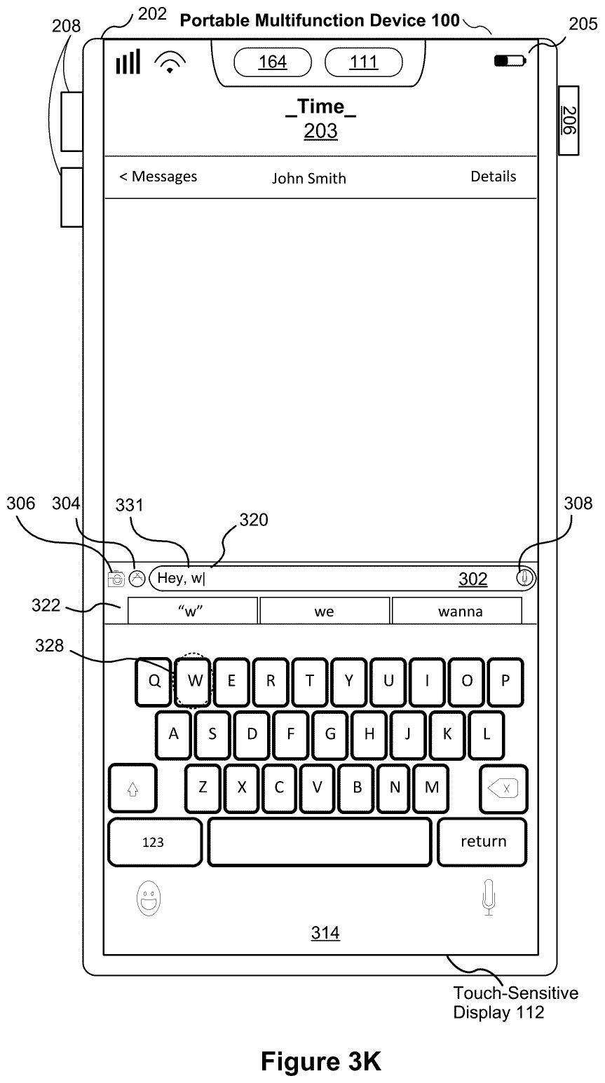

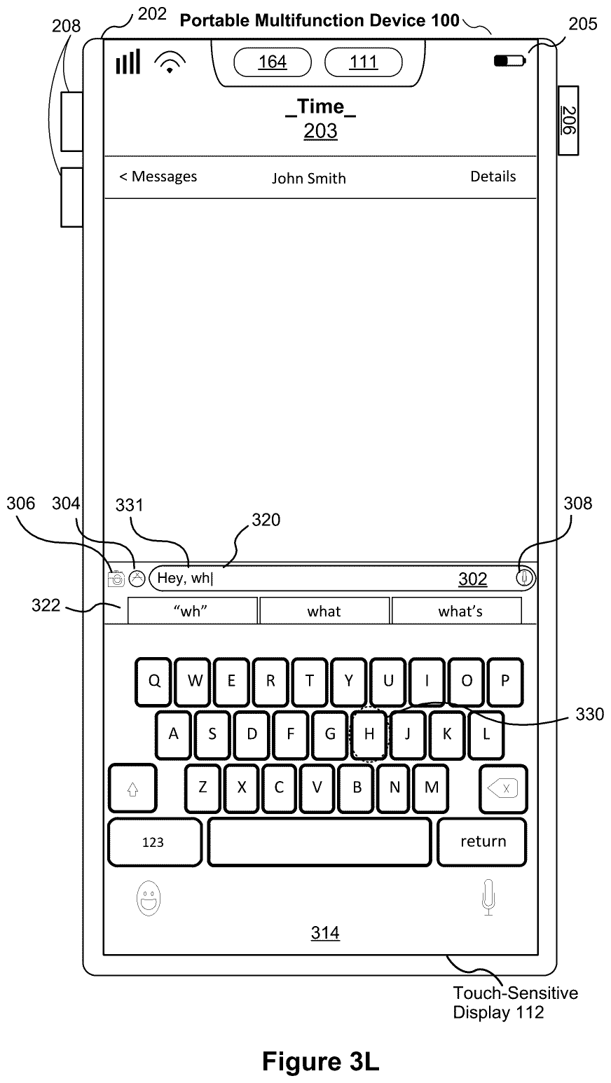

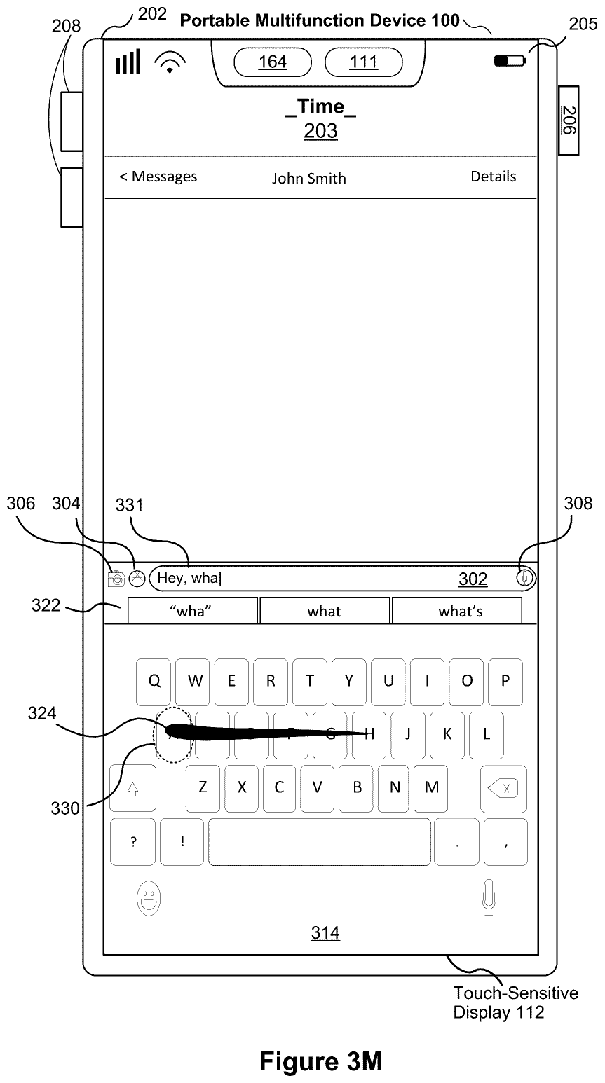

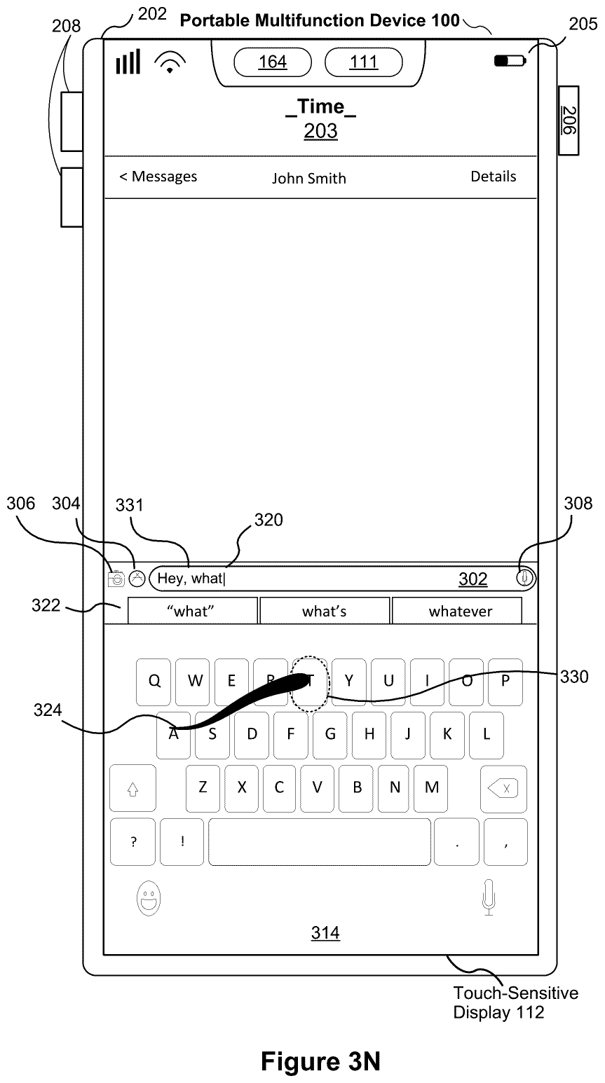

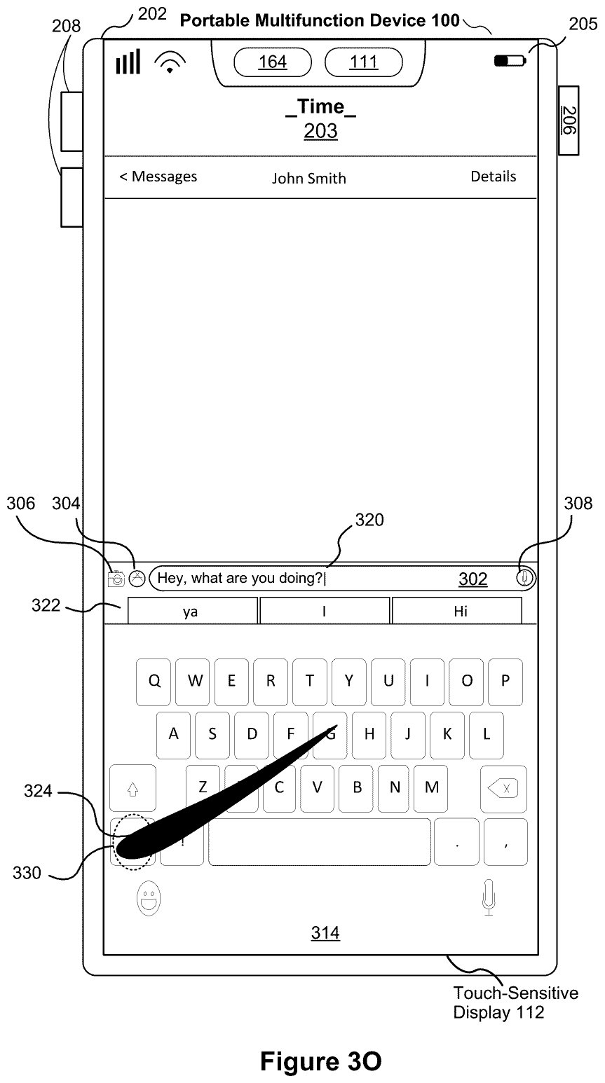

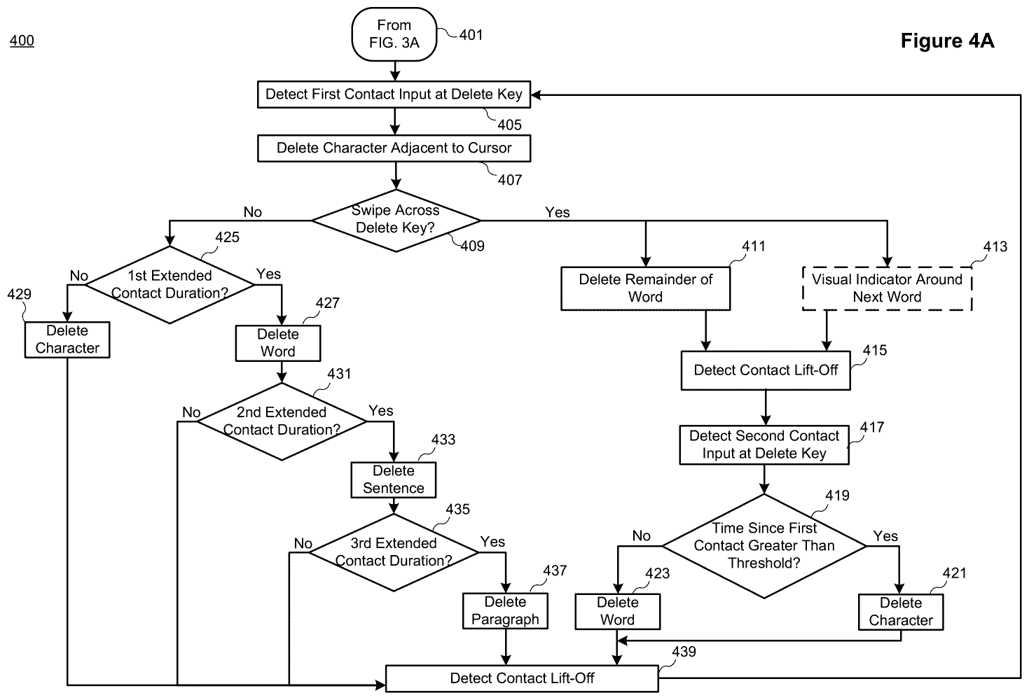

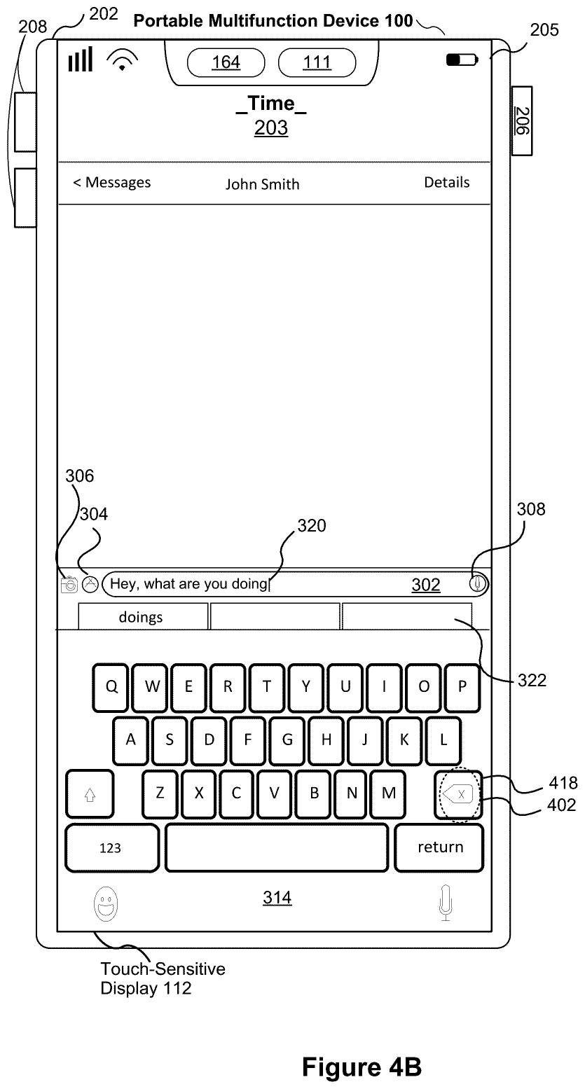

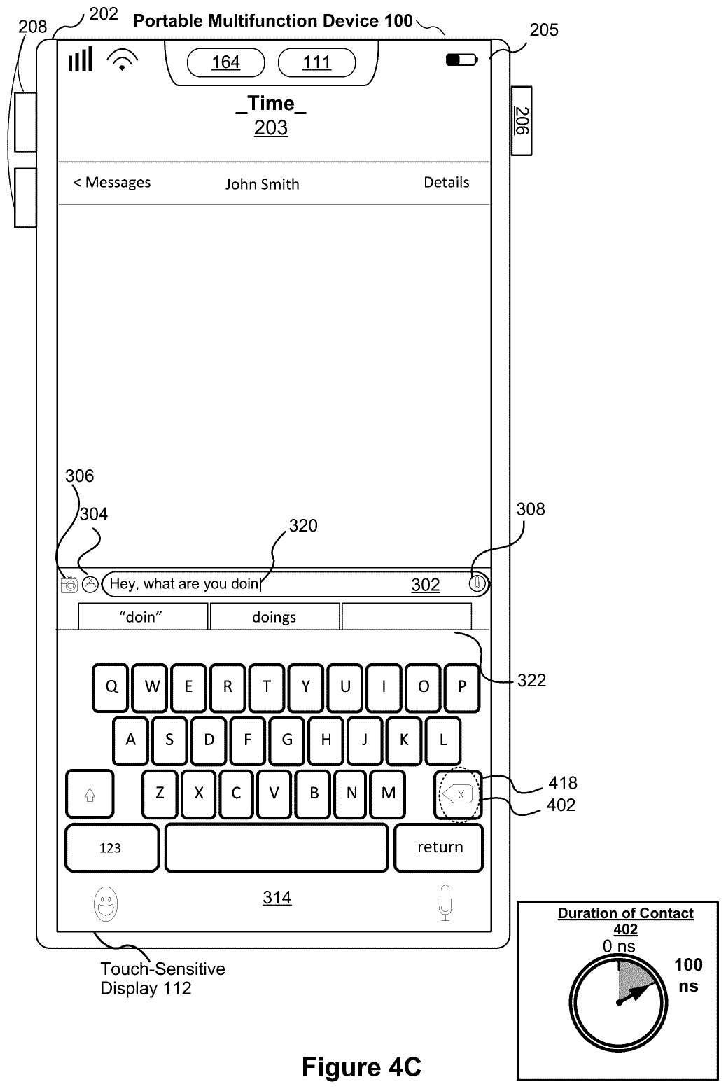

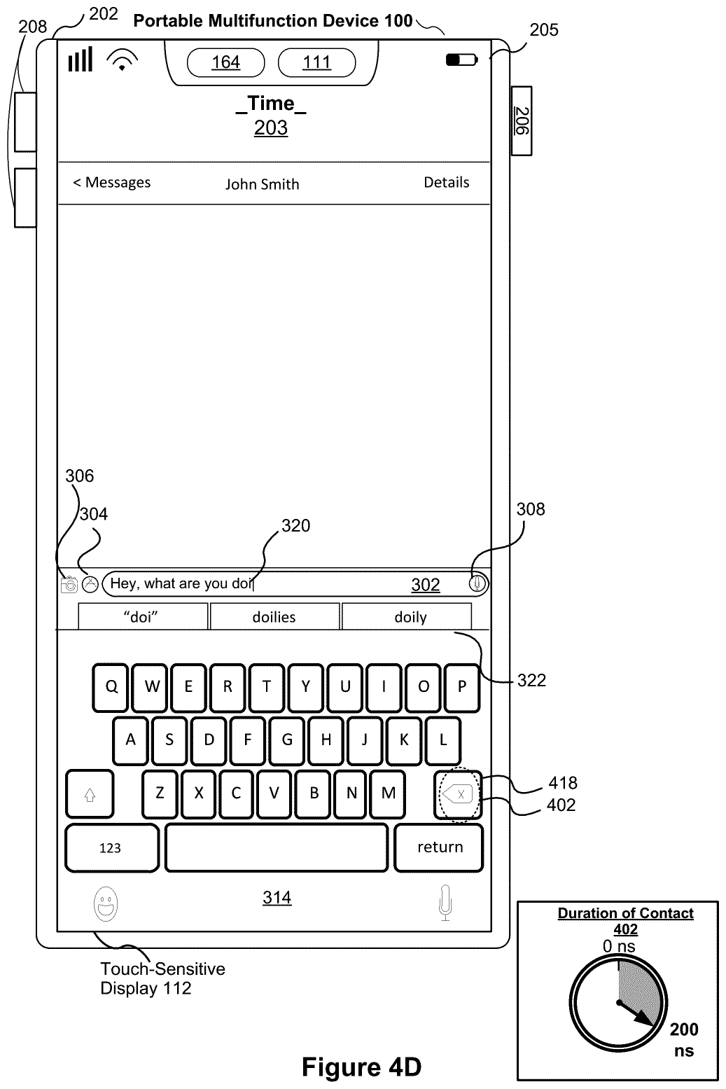

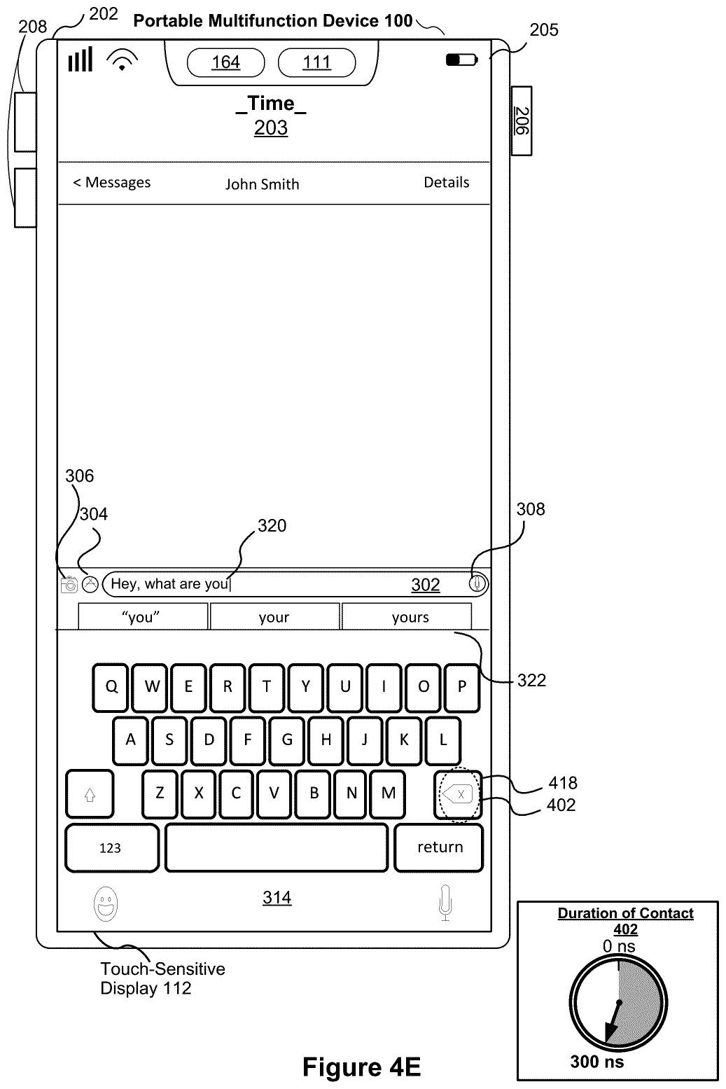

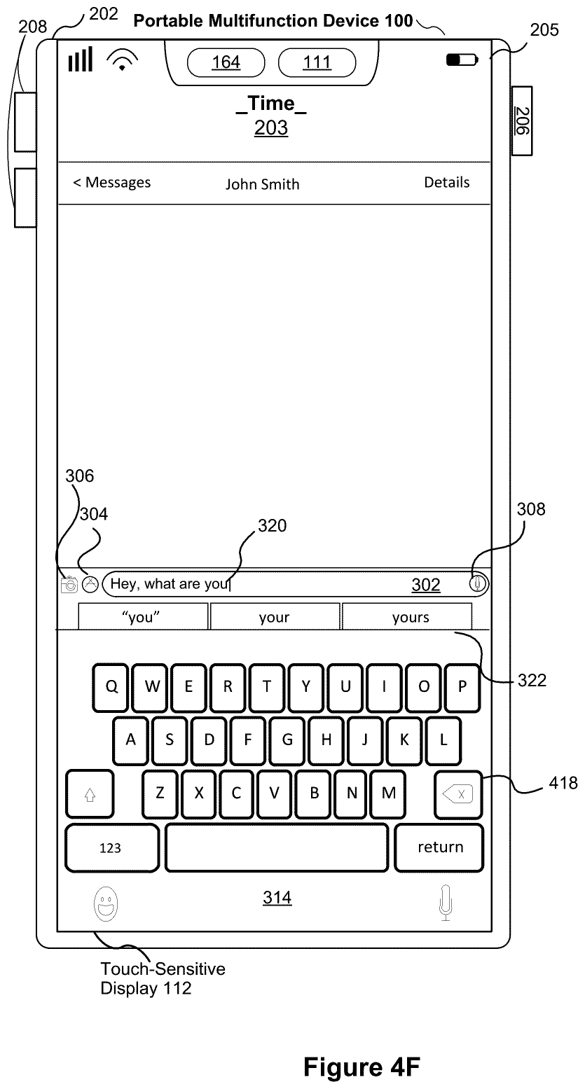

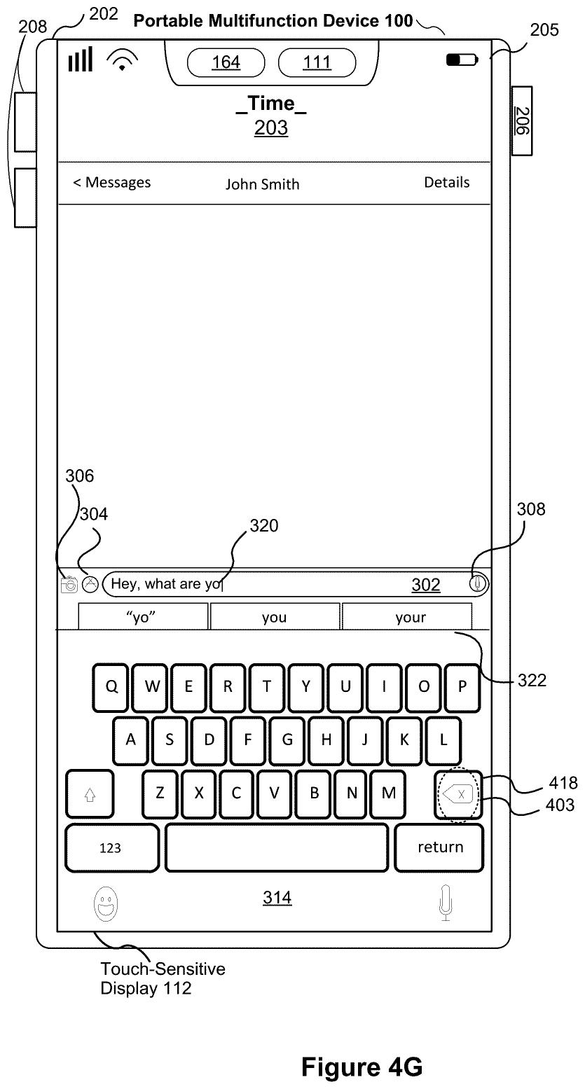

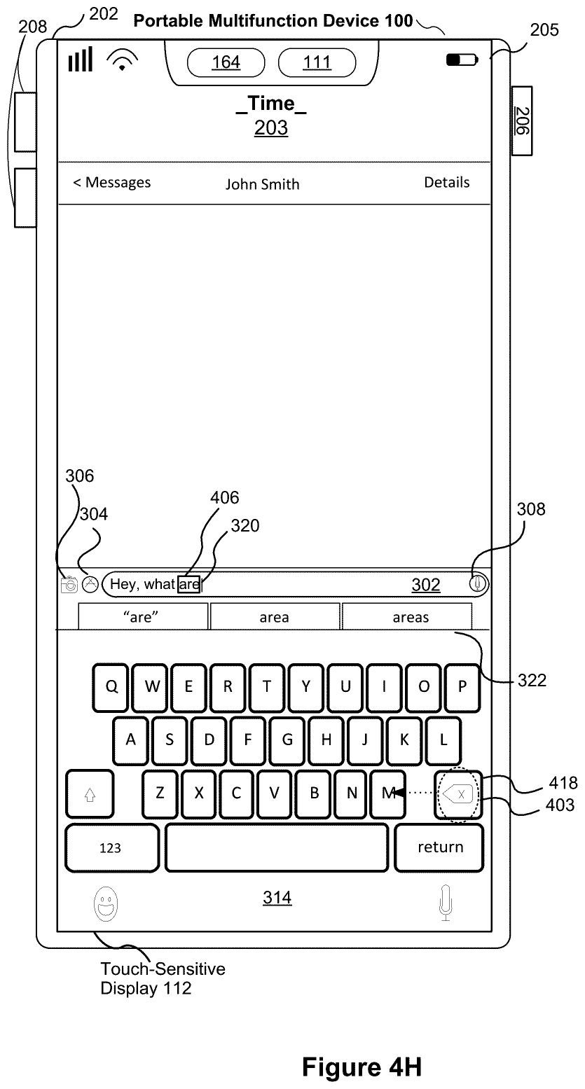

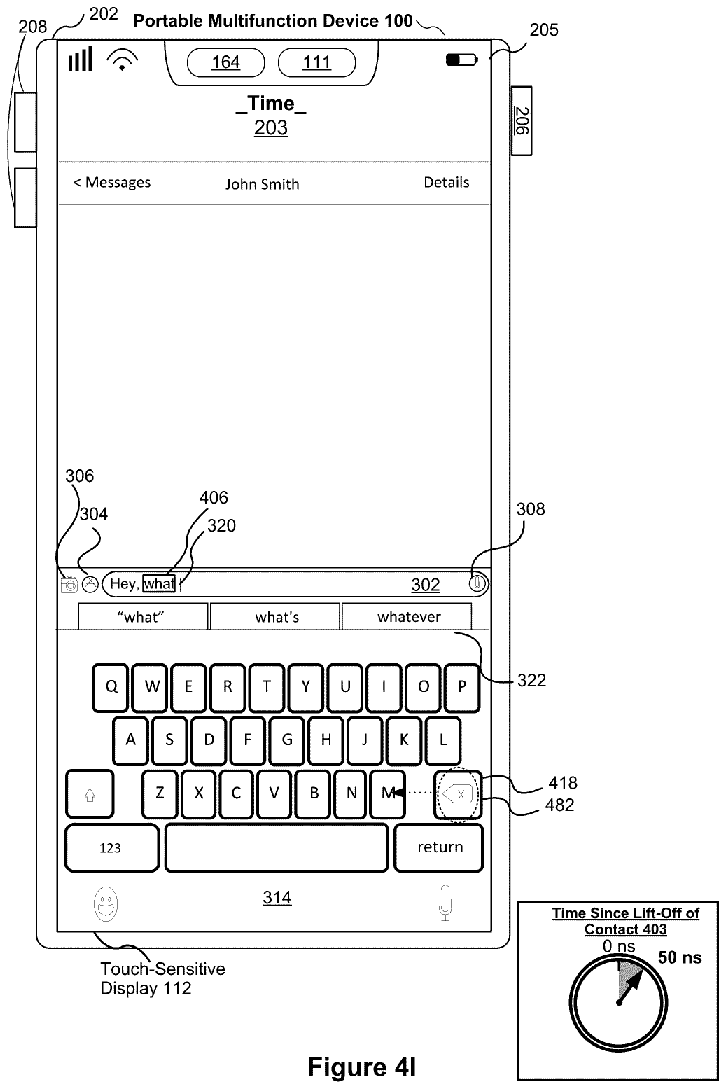

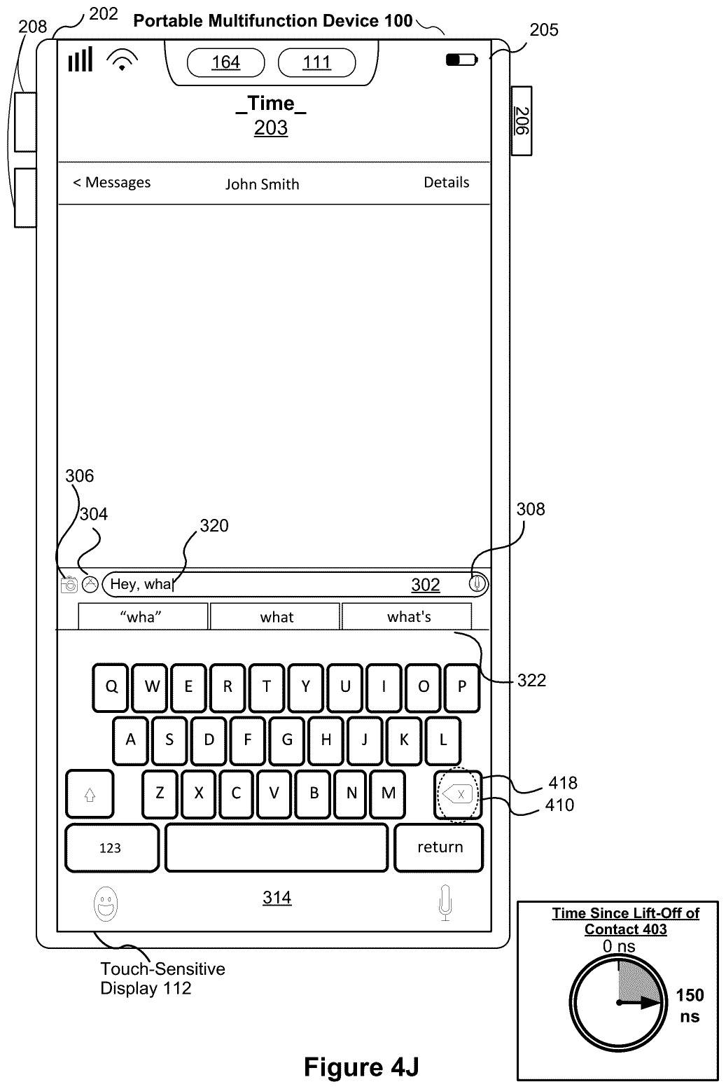

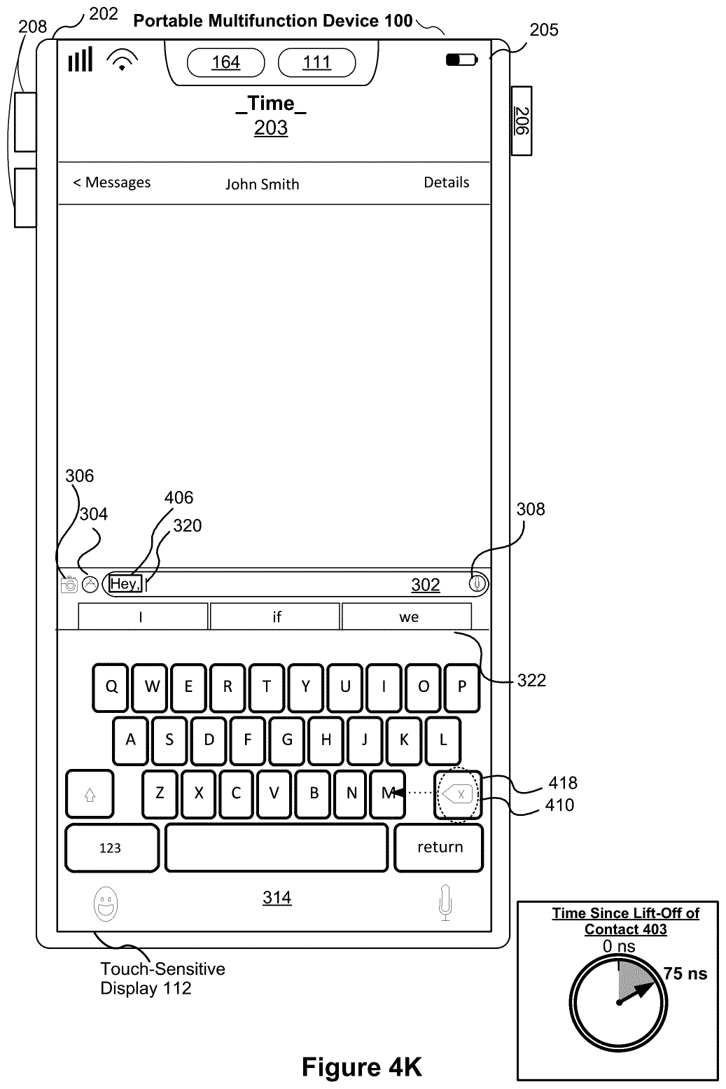

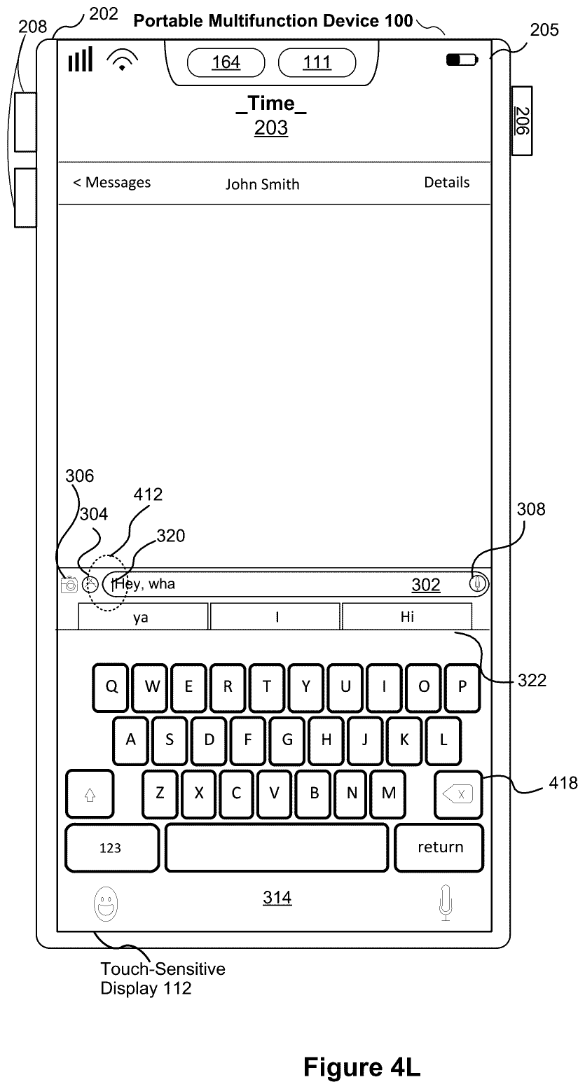

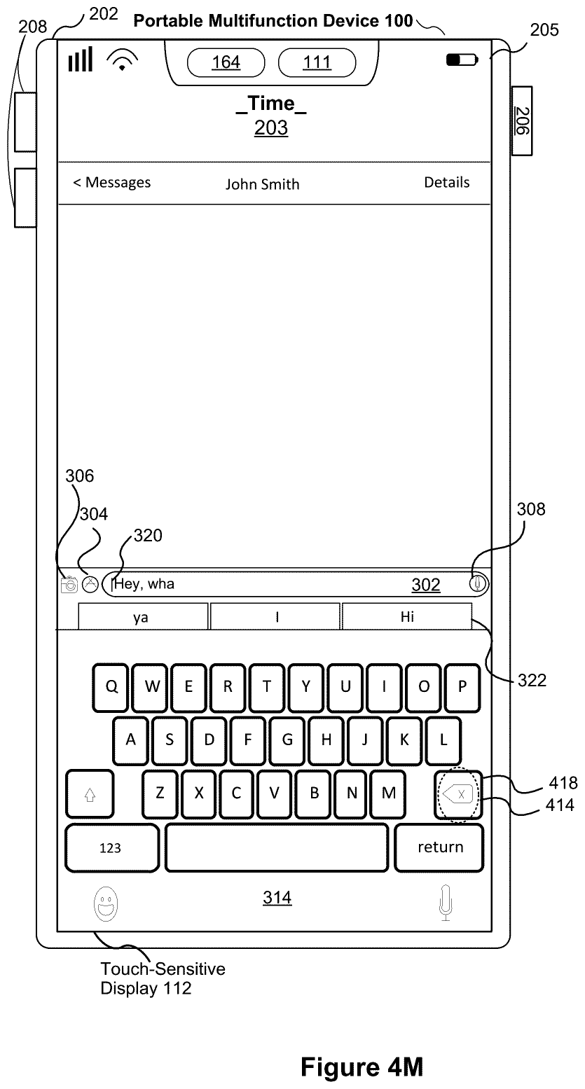

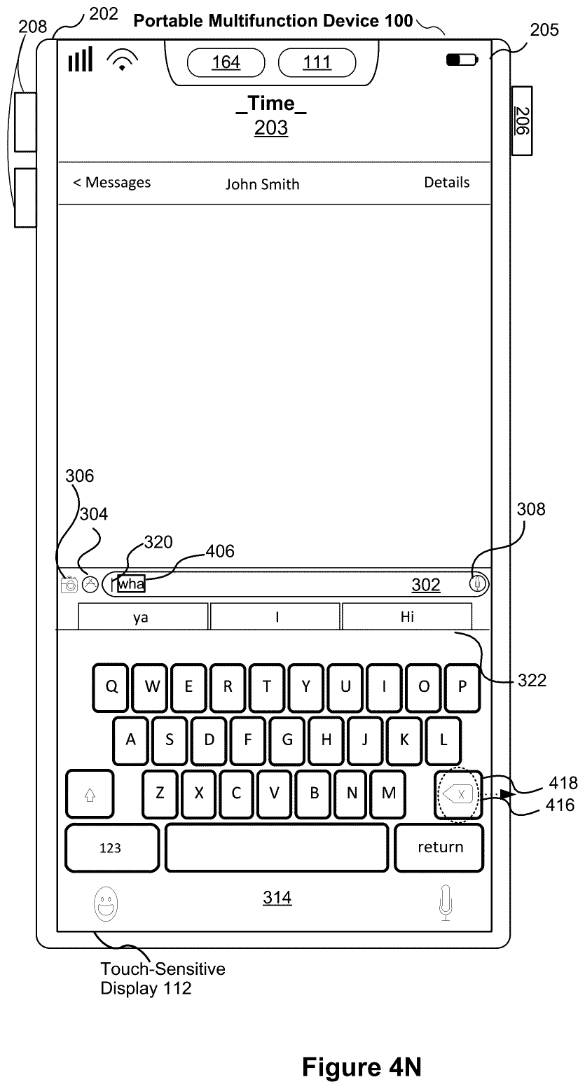

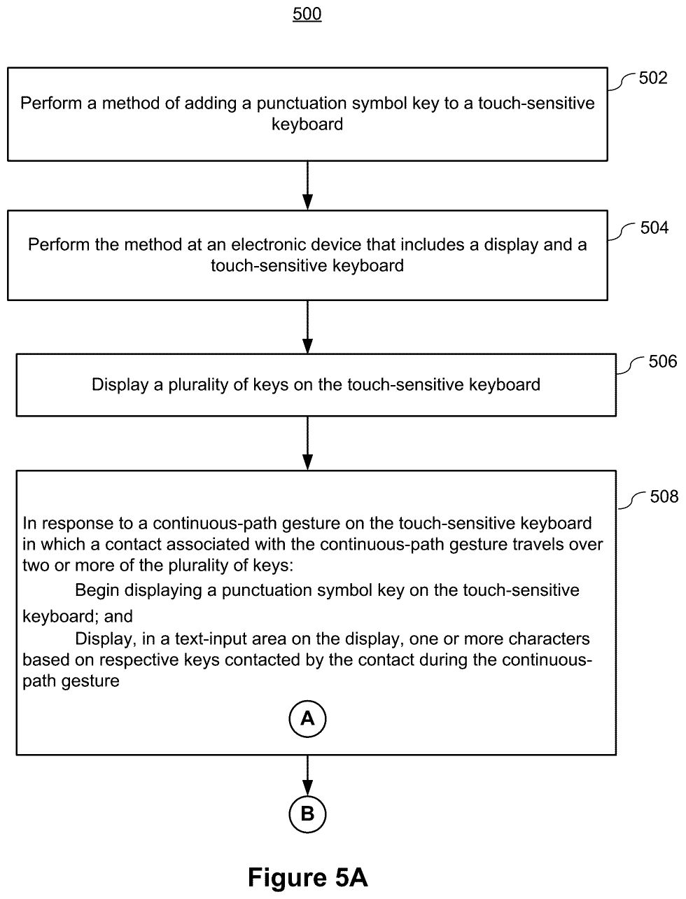

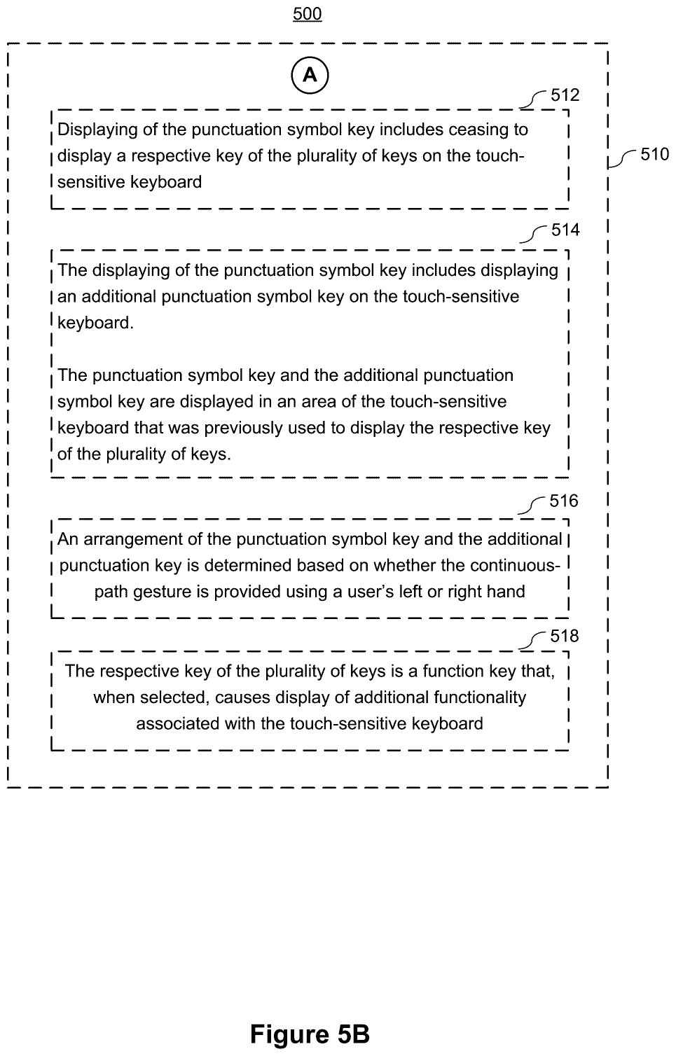

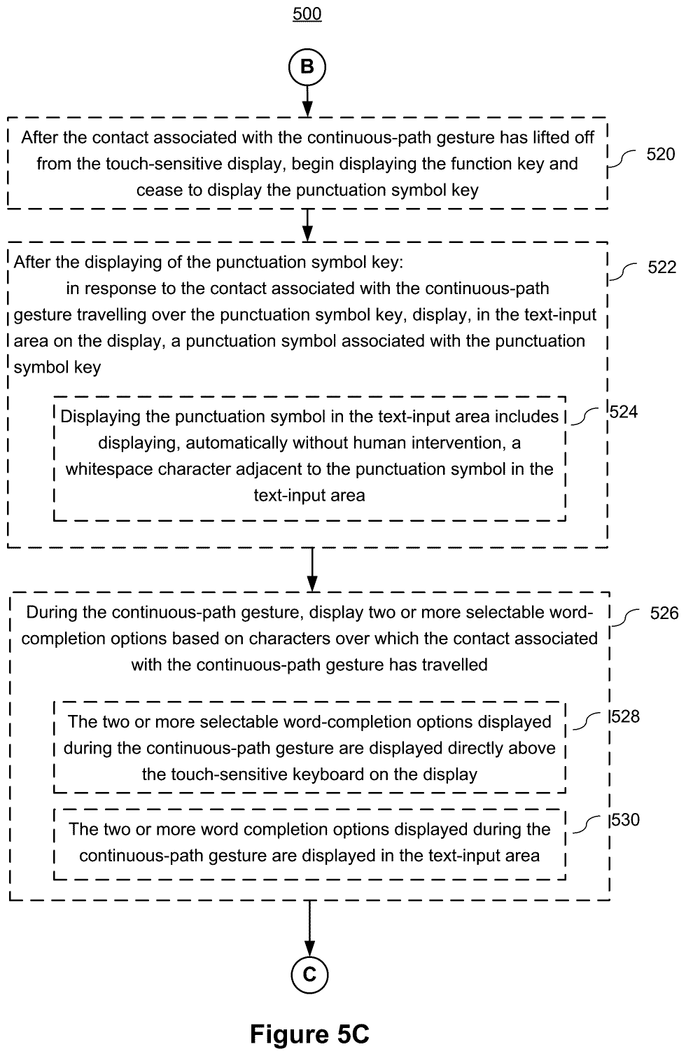

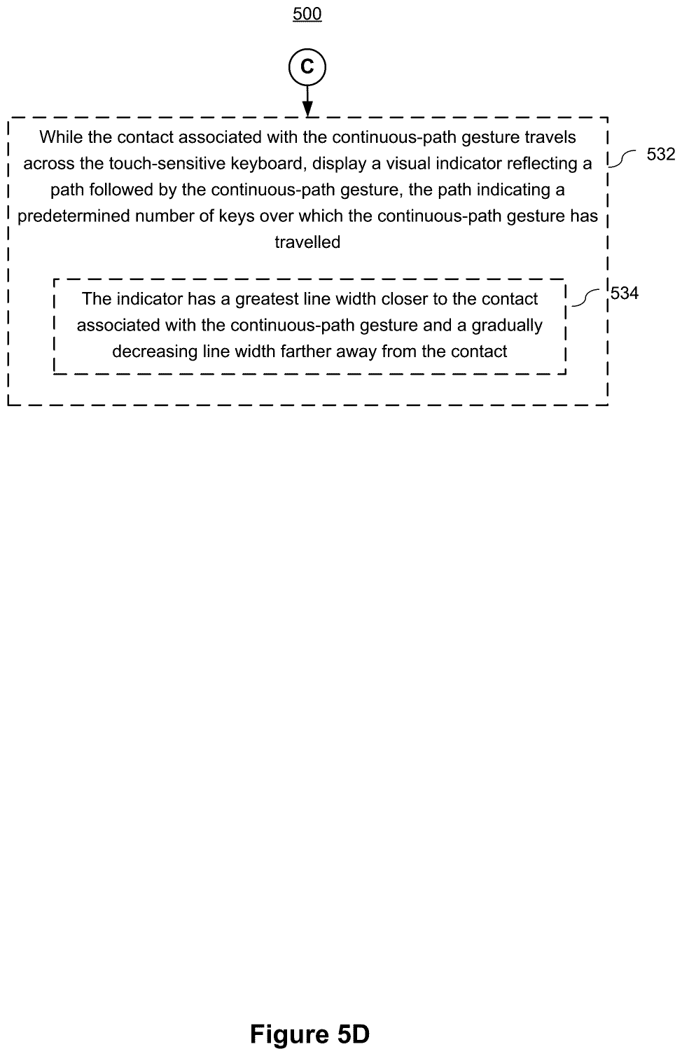

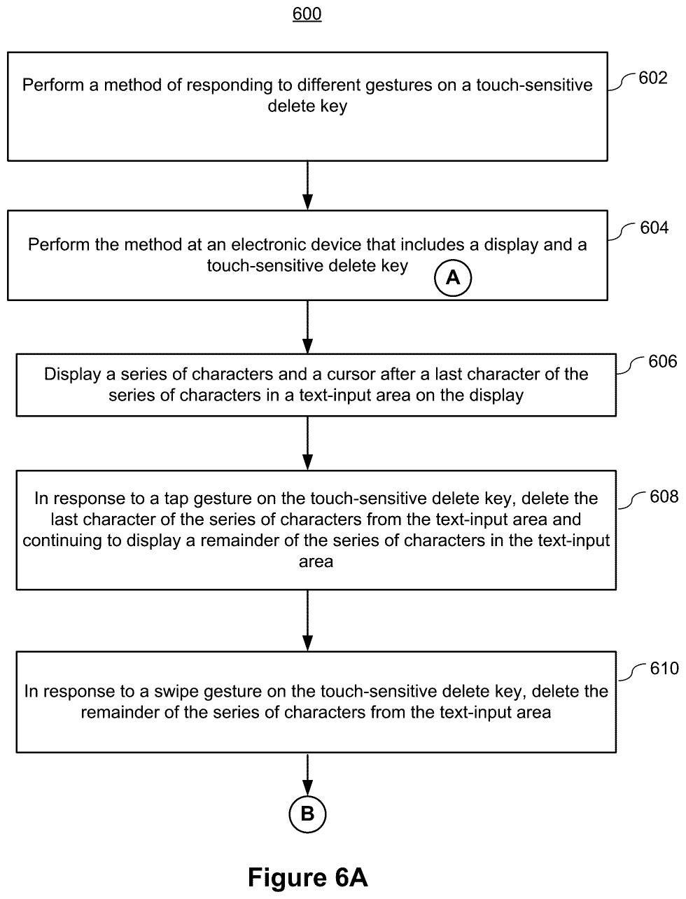

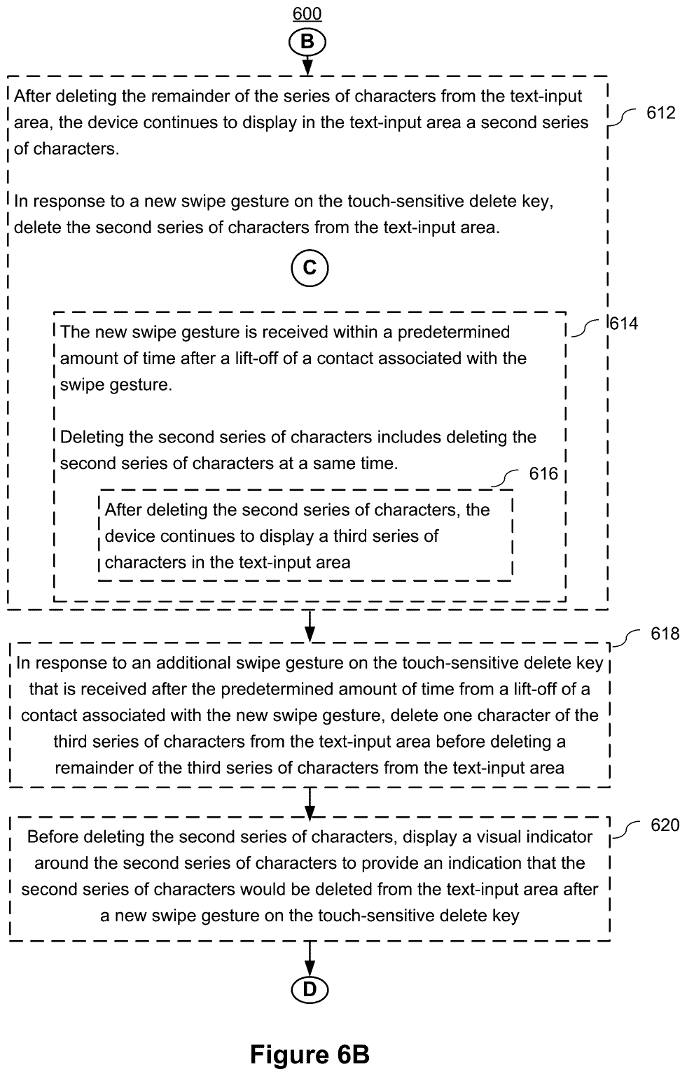

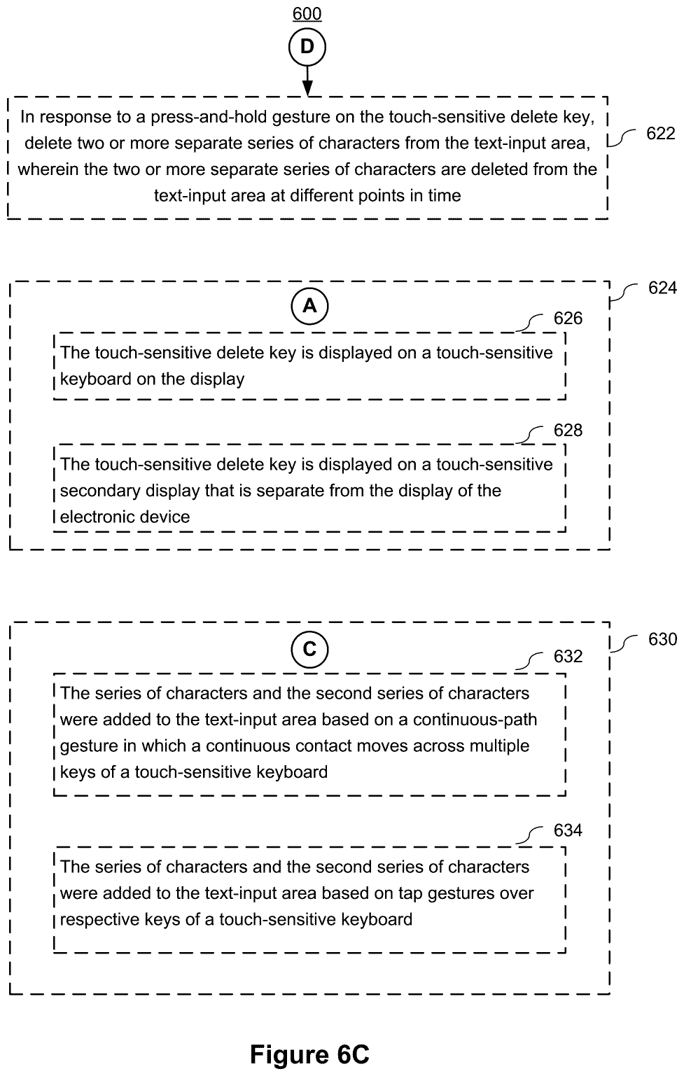

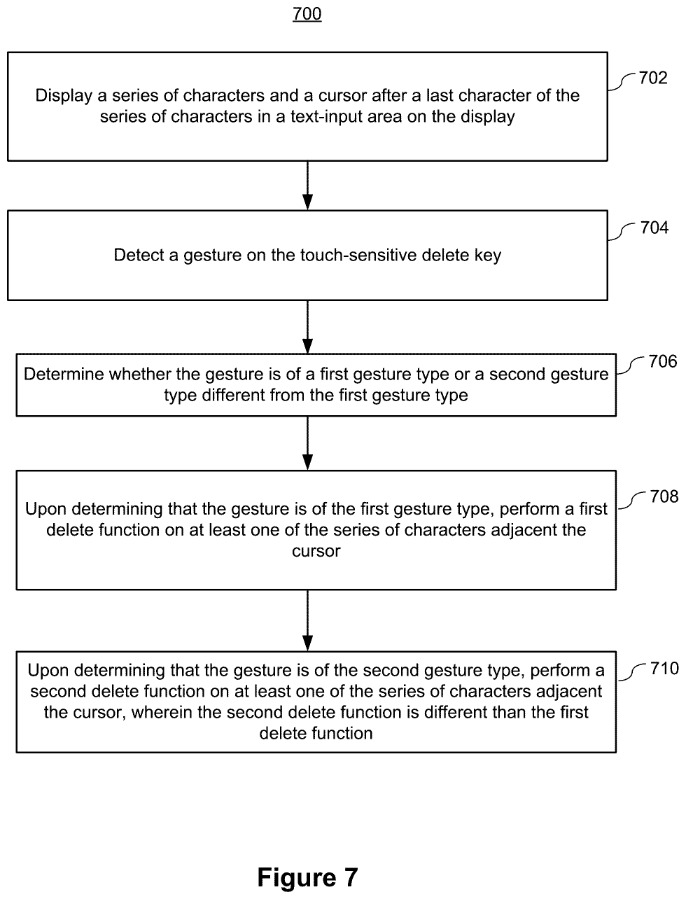

Below, the descriptions of FIGS. 1A-1D, 2, 3B-3D, and 4B-4N are with reference to exemplary electronic devices and user interfaces. The description of FIG. 3A is with reference to a flowchart illustrating an exemplary method of responding to a continuous-path gesture at a touch-sensitive keyboard. The description of FIG. 4A is with reference to a flowchart illustrating an exemplary method of responding to a delete key gesture at a touch-sensitive keyboard. The descriptions of FIGS. 5A-5D are with reference to flowcharts illustrating exemplary methods of adding a punctuation symbol key to a touch-sensitive keyboard. The descriptions of FIGS. 6A-6C and 7 are with reference to flowcharts illustrating exemplary methods of responding to different gestures on a touch-sensitive delete key. Accordingly, FIGS. 3A, 4A, 5A-5D, 6A-6C, and 7 illustrate methods and/or processes performed by the exemplary electronic devices of FIGS. 1A-1D, 2, 3B-3D, and 4B-4N.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The disclosure herein interchangeably refers to detecting a touch input on, at, over, on top of, or substantially within a particular user interface element or a particular portion of a touch-sensitive display. As used herein, a touch input that is detected “at” a particular user interface element could also be detected “on,” “over, ” “on top of,” or “substantially within” that same user interface element, depending on the context. In some embodiments and as discussed in more detail below, desired sensitivity levels for detecting touch inputs are configured by a user of an electronic device (e.g., the user could decide (and configure the electronic device to operate) that a touch input should only be detected when the touch input is completely within a user interface element).

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the IPHONE®, IPOD TOUCH®, and IPAD® devices from APPLE Inc. of Cupertino, California. Other portable electronic devices, such as laptops or tablet computers with touch-sensitive surfaces (e.g., touch-sensitive displays and/or touch pads), are, optionally, used. It should also be understood that, in some embodiments, the device is not a portable communications device, but is a desktop computer with a touch-sensitive surface (e.g., a touch-sensitive display and/or a touch pad). In the discussion that follows, an electronic device that includes a display and a touch-sensitive surface is described. It should be understood, however, that the electronic device optionally includes one or more other physical user-interface devices, such as a physical keyboard, a mouse and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a fitness application, a photo management application, a digital camera application, a digital video camera application, a web browsing application, a digital music player application, and/or a digital video player application. The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user. Attention is now directed toward embodiments of portable electronic devices with touch-sensitive displays.

FIG. 1A is a high-level block diagram of a computing device with a touch-sensitive display, in accordance with some embodiments. Touch-sensitive display 112 is sometimes called a “touch screen” for convenience, and is sometimes known as or called a touch-sensitive display system. Device 100 includes memory 102 (which optionally includes one or more computer-readable storage mediums), controller 120, one or more processing units (CPU's) 122, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more intensity sensors 165 for detecting intensity of contacts on device 100 (e.g., a touch-sensitive surface such as touch-sensitive display 112 of device 100). Device 100 optionally includes one or more tactile output generators 167 for generating tactile outputs on device 100 (e.g., generating tactile outputs on a touch-sensitive surface such as touch-sensitive display 112 of device 100 or a touchpad of device 100). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch sensitive surface, or to a substitute (proxy) for the force or pressure of a contact on the touch sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure and the estimated force or pressure is used to determine whether an intensity threshold has been exceeded (e.g., the intensity threshold is a pressure threshold measured in units of pressure).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as a “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application specific integrated circuits. Memory 102 optionally includes high-speed random access memory (e.g., DRAM, SRAM, DDR RAM or other random access solid state memory devices) and optionally also includes non-volatile memory, such as one or more magnetic disk storage devices, flash memory devices, or other non-volatile solid-state memory devices. Memory 102 optionally includes one or more storage devices remotely located from processor(s) 122. Access to memory 102 by other components of device 100, such as CPU 122 and the peripherals interface 118, is, optionally, controlled by controller 120.

Peripherals interface 118 can be used to couple input and output peripherals of the device to CPU 122 and memory 102. The one or more processors 122 run or execute various software programs and/or sets of instructions stored in memory 102 to perform various functions for device 100 and to process data. In some embodiments, peripherals interface 118, CPU 122, and controller 120 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication optionally uses any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, and/or Wireless Fidelity (Wi-Fi) (e.g., IEEE 802.11a, IEEE 802.11b, IEEE 802.11 g and/or IEEE 802.11n).

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack. The headset jack provides an interface between audio circuitry 110 and removable audio input/output peripherals, such as output-only headphones or a headset with both output (e.g., a headphone for one or both cars) and input (e.g., a microphone).

I/O subsystem 106 connects input/output peripherals on device 100, such as touch-sensitive display 112 and other input control devices 116, to peripherals interface 118. I/O subsystem 106 optionally includes display controller 156, optical sensor controller 158, intensity sensor controller 159, haptic feedback controller 161, and one or more input controllers 160 for other input or control devices. The one or more input controllers 160 receive/send electrical signals from/to other input or control devices 116. The other input control devices 116 optionally include physical buttons (e.g., push buttons, rocker buttons, etc.), dials, slider switches, joysticks, click wheels, and so forth. In some alternate embodiments, input controller(s) 160 are, optionally, coupled to any (or none) of the following: a keyboard, infrared port, USB port, and a pointer device such as a mouse. The one or more buttons optionally include an up/down button for volume control of speaker 111 and/or microphone 113. The one or more buttons optionally include a push button.

Touch-sensitive display 112 provides an input interface and an output interface between the device and a user. Display controller 156 receives and/or sends electrical signals from/to touch-sensitive display 112. Touch-sensitive display 112 displays visual output to the user. The visual output optionally includes graphics, text, icons, video, and any combination thereof (collectively termed “graphics”). In some embodiments, some or all of the visual output corresponds to user-interface objects. Touch-sensitive display 112 has a touch-sensitive surface, a sensor or a set of sensors that accepts input from the user based on haptic and/or tactile contact. Touch-sensitive display 112 and display controller 156 (along with any associated modules and/or sets of instructions in memory 102) detect contact (and any movement or breaking of the contact) on touch-sensitive display 112 and convert the detected contact into interaction with user-interface objects (e.g., one or more soft keys, icons, web pages or images) that are displayed on touch-sensitive display 112. In an exemplary embodiment, a point of contact between touch-sensitive display 112 and the user corresponds to an area under a finger of the user.

Touch-sensitive display 112 optionally uses LCD (liquid crystal display) technology, LPD (light emitting polymer display) technology, or LED (light emitting diode) technology, or OLED (organic light emitting diode) technology, although other display technologies are used in other embodiments. Touch-sensitive display 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch-sensitive display 112. In an exemplary embodiment, projected mutual capacitance sensing technology is used, such as that found in the IPHONE®, IPOD TOUCH®, and IPAD® from APPLE Inc. of Cupertino, California.

Touch-sensitive display 112 optionally has a video resolution in excess of 400 dpi. In some embodiments, touch-sensitive display 112 has a video resolution of at least 600 dpi. In other embodiments, touch-sensitive display 112 has a video resolution of at least 1000 dpi. The user optionally makes contact with touch-sensitive display 112 using any suitable object or digit, such as a stylus or a finger. In some embodiments, the user interface is designed to work primarily with finger-based contacts and gestures. In some embodiments, the device translates the finger-based input into a precise pointer/cursor position or command for performing the actions desired by the user. In some embodiments, in addition to the touch screen, device 100 optionally includes a touchpad (not shown) for activating or deactivating particular functions. In some embodiments, the touchpad is a touch-sensitive area of the device that, unlike the touch screen, does not display visual output. The touchpad is, optionally, a touch-sensitive surface that is separate from touch-sensitive display 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)), and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch-sensitive display 112 on the front of the device, so that the touch-sensitive display is enabled for use as a viewfinder for still and/or video image acquisition. In some embodiments, another optical sensor is located on the front of the device so that the user's image is, optionally, obtained for videoconferencing while the user views the other video conference participants on the touch-sensitive display.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display 112). In some embodiments, at least one contact intensity sensor is located on the back of device 100, opposite touch-sensitive display 112 which is located on the front of device 100. Device 100 optionally also includes one or more proximity sensors 166. FIG. 1A shows proximity sensor 166 coupled to peripherals interface 118. Alternately, proximity sensor 166 is coupled to input controller 160 in I/O subsystem 106. In some embodiments, the proximity sensor turns off and disables touch-sensitive display 112 when the multifunction device is placed near the user's car (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch-sensitive display 112 which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. In some embodiments, information is displayed on the touch-sensitive display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments memory 102 stores device/global internal state 157, keyboard input analysis module 163 (e.g., a module that is used in conjunction with the methods described herein to analyze inputs and determine whether or not to enter a continuous-path keyboard mode), continuous-path keyboard module 163-1 (e.g., a module that is used to manage a keyboard while it is in a continuous-path keyboard mode, such as managing presentation of snakelike animation used to show a path traced by a user's finger on the keyboard, managing replacement of function keys with punctuation keys, etc.), and delete gesture module 163-2 (e.g., a module used to manage delete-key gesture operations, including a swipe gesture over the delete key as described below), as shown in FIG. 1A. Device/global internal state 157 includes one or more of: active application state, indicating which applications, if any, are currently active; display state, indicating what applications, views or other information occupy various regions of touch-sensitive display 112; sensor state, including information obtained from the device's various sensors and input control devices 116; and location information concerning the device's location and/or attitude (i.e., orientation of the device).

Operating system 126 (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components. Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used on some embodiments of IPOD devices from APPLE Inc. In other embodiments, the external port is a multi-pin (e.g., 8-pin) connector that is the same as, or similar to and/or compatible with the 8-pin connector used in LIGHTNING connectors from APPLE Inc.

Contact/motion module 130 optionally detects contact with touch-sensitive display 112 (in conjunction with display controller 156) and other touch sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has selected or “clicked” on an affordance). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch-sensitive display can be set to any of a large range of predefined thresholds values without changing the trackpad or touch-sensitive display hardware. Additionally, in some implementations a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and, in some embodiments, subsequently followed by detecting a finger-up (liftoff) event.

Graphics module 132 includes various known software components for rendering and displaying graphics on touch-sensitive display 112 or other display, including components for changing the visual impact (e.g., brightness, transparency, saturation, contrast, or other visual property) of graphics that are displayed. As used herein, the term “graphics” includes any object that can be displayed to a user, including without limitation text, web pages, icons (such as user-interface objects including soft keys), digital images, videos, animations and the like. In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinating data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100. Text input module 134, which is, optionally, a component of graphics module 132, provides soft keyboards for entering text in various applications (e.g., contacts module 137, e-mail client module 140, IM module 141, browser module 147, and any other application that needs text input). GPS module 135 determines the location of the device and provides this information for use in various applications (e.g., to telephone module 138 for use in location-based dialing, to camera module 143 as picture/video metadata, and to applications that provide location-based services such as weather widgets, local yellow page widgets, and map/navigation widgets).

Applications (“apps”) 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
fitness module 142;
camera module 143 for still and/or video images;
image management module 144;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
search module 151;
video and music player module 152, which is, optionally, made up of a video player module and a music player module;
notes module 153;
map module 154; and/or
online video module 155.

Examples of other applications 136 that are, optionally, stored in memory 102 include other word processing applications, other image editing applications, drawing applications, presentation applications, website creation applications, disk authoring applications, spreadsheet applications, JAVA-enabled applications, encryption, digital rights management, voice recognition, widget creator module for making user-created widgets 149-6, and voice replication. In conjunction with touch-sensitive display 112, display controller 156, contact module 130, graphics module 132, and text input module 134, contacts module 137 is, optionally, used to manage an address book or contact list (e.g., stored in contacts module 137 in memory 102), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch-sensitive display 112, display controller 156, contact module 130, graphics module 132, and text input module 134, telephone module 138 is, optionally, used to enter a sequence of characters corresponding to a telephone number, access one or more telephone numbers in address book 137, modify a telephone number that has been entered, dial a respective telephone number, conduct a conversation and disconnect or hang up when the conversation is completed. As noted above, the wireless communication optionally uses any of a plurality of communications standards, protocols and technologies. In conjunction with RF circuitry 108, audio circuitry 110, speaker 111, microphone 113, touch-sensitive display 112, display controller 156, optical sensor 164, optical sensor controller 158, contact module 130, graphics module 132, text input module 134, contact list 137, and telephone module 138, videoconferencing module 139 includes executable instructions to initiate, conduct, and terminate a video conference between a user and one or more other participants in accordance with user instructions.

In conjunction with RF circuitry 108, touch-sensitive display 112, display controller 156, contact module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143. In conjunction with RF circuitry 108, touch-sensitive display 112, display controller 156, contact module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages and to view received instant messages. In some embodiments, transmitted and/or received instant messages optionally include graphics, photos, audio files, video files, and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch-sensitive display 112, display controller 156, contact module 130, graphics module 132, text input module 134, GPS module 135, map module 154, and video and music player module 146, fitness module 142 includes executable instructions to create workouts (e.g., with time, distance, and/or calorie burning goals), communicate with workout sensors (sports devices such as a watch or a pedometer), receive workout sensor data, calibrate sensors used to monitor a workout, select and play music for a workout, and display, store and transmit workout data. In conjunction with touch-sensitive display 112, display controller 156, optical sensor(s) 164, optical sensor controller 158, contact module 130, graphics module 132, and image management module 144, camera module 143 includes executable instructions to capture still images or video (including a video stream) and store them into memory 102, modify characteristics of a still image or video, or delete a still image or video from memory 102. In conjunction with touch-sensitive display 112, display controller 156, contact module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch-sensitive display 112, display system controller 156, contact module 130, graphics module 132, and text input module 134, browser module 147 includes executable instructions to browse the Internet in accordance with user instructions, including searching, linking to, receiving, and displaying web pages or portions thereof, as well as attachments and other files linked to web pages. In conjunction with RF circuitry 108, touch-sensitive display 112, display system controller 156, contact module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions. In conjunction with RF circuitry 108, touch-sensitive display 112, display system controller 156, contact module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets). In conjunction with RF circuitry 108, touch-sensitive display 112, display system controller 156, contact module 130, graphics module 132, text input module 134, and browser module 147, a widget creator module (not pictured) is, optionally, used by a user to create widgets (e.g., turning a user-specified portion of a web page into a widget).

In conjunction with touch-sensitive display 112, display system controller 156, contact module 130, graphics module 132, and text input module 134, search module 151 includes executable instructions to search for text, music, sound, image, video, and/or other files in memory 102 that match one or more search criteria (e.g., one or more user-specified search terms) in accordance with user instructions. In conjunction with touch-sensitive display 112, display system controller 156, contact module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present or otherwise play back videos (e.g., on touch-sensitive display 112 or on an external, connected display via external port 124). In some embodiments, device 100 optionally includes the functionality of an MP3 player, such as an IPOD from APPLE Inc. In conjunction with touch-sensitive display 112, display controller 156, contact module 130, graphics module 132, and text input module 134, notes module 153 includes executable instructions to create and manage notes, to-do lists, and the like in accordance with user instructions.

In conjunction with RF circuitry 108, touch-sensitive display 112, display system controller 156, contact module 130, graphics module 132, text input module 134, GPS module 135, and browser module 147, map module 154 is, optionally, used to receive, display, modify, and store maps and data associated with maps (e.g., driving directions; data on stores and other points of interest at or near a particular location; and other location-based data) in accordance with user instructions. In conjunction with touch-sensitive display 112, display system controller 156, contact module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video.

As pictured in FIG. 1A, portable multifunction device 100 also includes a keyboard input analysis module 163 for analyzing input received at a touch-sensitive keyboard displayed on the touch-sensitive display 112. Keyboard input analysis module 163 optionally includes the following modules (or sets of instructions), or a subset or superset thereof:
continuous-path gesture module 163-1 for responding to a continuous-path gesture at a touch-sensitive keyboard; and
delete key gesture module 163-2 for responding to a delete key gesture at a touch-sensitive keyboard;

Each of the above-identified modules and applications correspond to a set of executable instructions for performing one or more functions described above and the methods described in this application (e.g., the computer-implemented methods and other information processing methods described herein). These modules (or sets of instructions) need not be implemented as separate software programs, procedures or modules, and thus various subsets of these modules are, optionally, combined or otherwise rearranged in various embodiments. In some embodiments, memory 102 optionally stores a subset of the modules and data structures identified above. Furthermore, memory 102 optionally stores additional modules and data structures not described above. In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced. The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a diagram used to illustrate exemplary components for event handling, in accordance with some embodiments. In some embodiments, memory 102 (in FIG. 1A) includes event sorter 170 (e.g., in operating system 126) and a respective application 136-1 selected from among the applications 136 of portable multifunction device 100 (FIG. 1A) (e.g., any of the aforementioned applications stored in memory 102 with applications 136). Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user. Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration). In some embodiments, event sorter 170 also includes a hit view determination module 172 and/or an active event recognizer determination module 173. Hit view determination module 172 provides software procedures for determining where a sub-event has taken place within one or more views, when touch sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture. Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (i.e., the first sub-event in the sequence of sub-events that form an event or potential event). Once the hit view is identified by the hit view determination module, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views. Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182. In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177 or GUI updater 178 to update the application internal state 192. Alternatively, one or more of the application views 191 includes one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170, and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions). Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from portrait to landscape, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event 187 include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first lift-off (touch end) for a predetermined phase, a second touch (touch begin) on the displayed object for a predetermined phase, and a second lift-off (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and lift-off of the touch (touch end). In some embodiments, the event also includes information for one or more associated event handlers 190.

In some embodiments, event definition 186 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test. In some embodiments, the definition for a respective event 187 also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any remain active for the hit view, continue to track and process sub-events of an ongoing touch-based gesture. In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy. In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process. In some embodiments, data updater 176 creates and updates data used in application 136-1. For example, data updater 176 updates the telephone number used in contacts module 137, or stores a video file used in video and music player module 145. In some embodiments, object updater 177 creates and updates objects used in application 136-1. For example, object updater 176 creates a new user-interface object or updates the position of a user-interface object. GUI updater 178 updates the GUI. For example, GUI updater 178 prepares display information and sends it to graphics module 132 for display on a touch- sensitive display. In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input-devices, not all of which are initiated on touch screens. For example, mouse movement and mouse button presses, optionally coordinated with single or multiple keyboard presses or holds; contact movements such as taps, drags, scrolls, etc., on touch-pads; pen stylus inputs; movement of the device; oral instructions; detected eye movements; biometric inputs; and/or any combination thereof is optionally utilized as inputs corresponding to sub-events which define an event to be recognized.

FIG. 1C is a diagram used to illustrate a portable multifunction device having a touch-sensitive display, in accordance with some embodiments. In some embodiments, as well as others described below, a user can select one or more graphics displayed on the touch-sensitive display by making a gesture on the screen, for example, with one or more fingers or one or more styluses. In some embodiments, selection of one or more graphics occurs when the user breaks contact with the one or more graphics (e.g., by lifting a finger off of the screen). In some embodiments, the gesture optionally includes one or more tap gestures (e.g., a sequence of touches on the screen followed by liftoffs), one or more swipe gestures (continuous contact during the gesture along the surface of the screen, e.g., from left to right, right to left, upward and/or downward), and/or a rolling of a finger (e.g., from right to left, left to right, upward and/or downward) that has made contact with device 100. In some implementations or circumstances, inadvertent contact with a graphic does not select the graphic. For example, a swipe gesture that sweeps over an application affordance (e.g., an icon) optionally does not launch (e.g., open) the corresponding application when the gesture for launching the application is a tap gesture.

FIG. 1D is a diagram used to illustrate a user interface on a device with a touch-sensitive surface that is separate from a touch-sensitive display, in accordance with some embodiments. In some embodiments, a touch-sensitive surface 195 includes one or more contact intensity sensors (e.g., one or more of contact intensity sensor(s) 165) for detecting intensity of contacts on touch-sensitive surface 195 and/or one or more tactile output generator(s) 167 for generating tactile outputs for a user of touch-sensitive surface 195.

Although some of the examples which follow will be given with reference to inputs on touch-sensitive display 112 (where the touch sensitive surface and the display are combined), in some embodiments, the device detects inputs on a touch-sensitive surface that is separate from the display, as shown in FIG. 1D. In some embodiments the touch sensitive surface (e.g., 195 in FIG. 1D) has a primary axis (e.g., 199 in FIG. 1D) that corresponds to a primary axis (e.g., 198 in FIG. 1D) on the display (e.g., 194). In accordance with these embodiments, the device detects contacts (e.g., 197-1 and 197-2 in FIG. 1D) with the touch-sensitive surface 195 at locations that correspond to respective locations on the display (e.g., in FIG. 1D, 197-1 corresponds to 196-1 and 197-2 corresponds to 196-2). In this way, user inputs (e.g., contacts 197-1 and 197-2, and movements thereof) detected by the device on the touch-sensitive surface (e.g., 195 in FIG. 1D) are used by the device to manipulate the user interface on the display (e.g., 194 in FIG. 1D) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or mouse and finger contacts are, optionally, used simultaneously.

As used herein, the term “focus selector” refers to an input element that indicates a current part of a user interface with which a user is interacting. In some implementations that include a cursor or other location marker, the cursor acts as a “focus selector,” so that when an input (e.g., a press input) is detected on a touch-sensitive surface (e.g., touch-sensitive surface 195 in FIG. 1D (touch-sensitive surface 195, in some embodiments, is a touchpad)) while the cursor is over a particular user interface element (e.g., a button, window, slider or other user interface element), the particular user interface element is adjusted in accordance with the detected input. In some implementations that include a touch-screen display (e.g., touch- sensitive display 112 in FIG. 1A) that enables direct interaction with user interface elements on the touch-screen display, a detected contact on the touch-screen acts as a “focus selector,” so that when an input (e.g., a press input by the contact) is detected on the touch-screen display at a location of a particular user interface element (e.g., a button, window, slider or other user interface element), the particular user interface element is adjusted in accordance with the detected input.

In some implementations, focus is moved from one region of a user interface to another region of the user interface without corresponding movement of a cursor or movement of a contact on a touch-screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch-screen display) that is controlled by the user so as to communicate the user's intended interaction with the user interface (e.g., by indicating, to the device, the element of the user interface with which the user is intending to interact). For example, the location of a focus selector (e.g., a cursor, a contact or a selection box) over a respective button while a press input is detected on the touch-sensitive surface (e.g., a touchpad or touch-sensitive display) will indicate that the user is intending to activate the respective button (as opposed to other user interface elements shown on a display of the device). Attention is now directed towards user interface (“UI”) embodiments and associated processes that may be implemented on an electronic device with a display and a touch-sensitive surface, such as device 100.

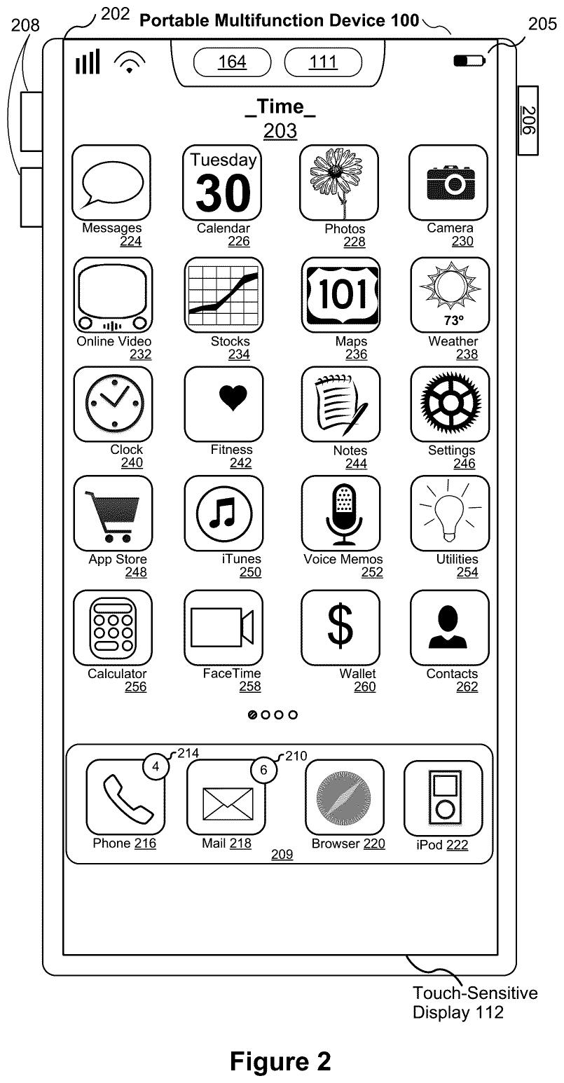

FIG. 2 is a diagram used to illustrate a user interface for a menu of

applications, in accordance with some embodiments. Similar user interfaces are, optionally, implemented on device 100 (FIG. 1A). In some embodiments, the user interface for the menu of applications includes the following elements, or a subset or superset thereof:
Signal strength indicator(s) 202 for wireless communication(s), such as cellular and Wi-Fi signals;
Time 203;
Battery status indicator 205;
Tray 209 with icons for frequently used applications, such as:
   Icon 216 for telephone module 138, labeled “Phone,” which optionally includes an indicator 214 of the number of missed calls or voicemail messages;
   Icon 218 for e-mail client module 140, labeled “Mail,” which optionally includes an indicator 210 of the number of unread e-mails;
   Icon 220 for browser module 147, labeled “Browser;” and
   Icon 222 for video and music player module 152, also referred to as IPOD (trademark of APPLE Inc.) module 152, labeled “iPod;” and
Icons for other applications, such as:
   Icon 224 for IM module 141, labeled “Messages;”
   Icon 226 for calendar module 148, labeled “Calendar;”
   Icon 228 for image management module 144, labeled “Photos;”
   Icon 230 for camera module 143, labeled “Camera;”
   Icon 232 for online video module 155, labeled “Online Video”
   Icon 234 for stocks widget 149-2, labeled “Stocks;”
   Icon 236 for map module 154, labeled “Maps;”
   Icon 238 for weather widget 149-1, labeled “Weather;”
   Icon 240 for alarm clock widget 149-4, labeled “Clock;”
   Icon 242 for fitness module 142, labeled “Fitness;”
   Icon 244 for notes module 153, labeled “Notes;”
   Icon 246 for a settings application or module, which provides access to settings for device 100 and its various applications; and
   Other icons 248, 250, 252, 254, 256, 258, 260, and 262 for additional applications, such as App Store, iTunes, Voice Memos, Utilities, Calculator, FaceTime, Wallet, and Contacts, respectively.

It should be noted that the icon labels illustrated in FIG. 2 are merely exemplary. Other labels are, optionally, used for various application icons. For example, icon 242 for fitness module 142 is alternatively labeled “Fitness Support,” “Workout,” “Workout Support,” “Exercise,” “Exercise Support,” or “Health.” In some embodiments, a label for a respective application icon includes a name of an application corresponding to the respective application icon. In some embodiments, a label for a particular application icon is distinct from a name of an application corresponding to the particular application icon.

Device 100 optionally also includes one or more physical buttons, such as a “home” or menu button 204. As described previously, menu button 204 is, optionally, used to navigate to any application 136 in a set of applications that are, optionally executed on device 100. Alternatively, in some embodiments, the menu button is implemented as a soft key in a GUI displayed on touch-sensitive display 112. In one embodiment, device 100 includes touch-sensitive display 112, menu button 204, push button 206 for powering the device on/off and/or locking the device, volume adjustment button(s) 208, Subscriber Identity Module (SIM) card slot 210, head set jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch-sensitive display 112 and/or one or more tactile output generators 167 for generating tactile outputs for a user of device 100.

FIG. 3A is a flowchart illustrating a method 300 of responding to a continuous-path gesture at a touch-sensitive keyboard, in accordance with some embodiments. The method 300 can be performed on the device 100 discussed above, and operations associated with the method 300 can be embodied in a computer-readable storage-medium (e.g., a memory of the device 100). As shown in FIG. 3A, in some embodiments, while displaying a touch-sensitive keyboard (e.g., keyboard 314 depicted in FIG. 3F) on at least a portion of the touch-sensitive display 112, the device 100 detects (301) a contact (e.g., contact 323, FIG. 3F) at the touch-sensitive keyboard 314. For example, as illustrated in FIG. 3F, in response to detecting the contact 323, which is detected at the “H” key, the device 100 displays the “H” in a text-input area 302. The contact input can be made by the user using, for example, a finger or a stylus. Next, in some embodiments, the device 100 determines (303) whether the contact moves between keys on the touch-sensitive keyboard 314. For example, as illustrated in FIGS. 3F and 3G, the device 100 determines that the contact input 323 moves (creating a continuous-path gesture 324) between the “H” key and the “E” key. If the device 100 detects movement between keys on the touch-sensitive keyboard 314 (303-Yes), then the device 100 enters (305) continuous-path keyboard mode (e.g., a mode in which a continuous-path gesture at the keyboard is used to spell out (trace out) words), otherwise (303-No) the device 100 enters (307) normal keyboard mode (e.g., a mode in which taps inputs are utilized at the keyboard to spell out words).

In some embodiments, a path followed by the continuous-path gesture is represented using a continuous-path-gesture animation 324 (e.g., a snake-like animation or “visual indicator” of a path followed by the continuous-path gesture) that provides an indication to a user as to which keys have been passed over during the continuous-path gesture 324. In some embodiments, the snake-like animation has a greatest line width closer to a contact associated with the continuous-path gesture 324 (e.g., the most recent contact point on the keyboard) and a gradually decreasing line width farther away from the contact (e.g., a less recent contact point on the keyboard during the continuous-path gesture 324 than the current contact). As mentioned above, the continuous-path-gesture animation could reflect a path followed by the gesture, the path indicating a predetermined number of keys (e.g., 2, 3, 4, 5 or 6) over which the gesture has travelled. In some embodiments, the continuous-path-gesture animation 324 could also be displayed in ways in addition to or as a replacement for the snake-like animation, such as the boundaries around the keys of the touch-sensitive keyboard could be removed and/or lightened (FIGS. 3G-3I and 3M-3O), and/or the keys could be highlighted, could be lit-up, or could change color or size based on a path followed by the continuous-path gesture.

In some embodiments, after the device 100 causes the keyboard to enter a continuous-path keyboard mode, the device 100 replaces (309) one or more function keys with one or more punctuation keys on the keyboard, and lightens the boundaries around the keys of the touch-sensitive keyboard. For example, as illustrated in FIG. 3G, at the touch-sensitive keyboard 314, the device 100 replaces the “return” function key with the “?” and “!” punctuation keys (in other words, one function key is replaced with two different punctuation keys), and the number key with the “.” and “,” punctuation keys (in other words, one function is replaced with two different punctuation keys). In other embodiments, any number of displayed function keys could be replaced with other combinations of punctuation keys. Next, in some embodiments, the device 100 determines (311) while the continuous-path gesture is travelling across the keyboard which key(s) the contact 323 moves over during the continuous-path gesture. While in the continuous-path keyboard mode, users can select both alphanumeric and punctuation symbols, and the device monitors which keys are being travelled over to determine whether to cause display of alphanumeric symbols or punctuation symbols during the continuous-path gesture. If the device determines (311-Punctuation Key(s)) that the contact 323 moves over one or more punctuation key(s) during the continuous-path gesture (e.g., as shown in FIG. 3O contact 330 travels over a “?” punctuation key during a continuous-path gesture involving the contact 330), then the device 100 displays (313) one or more punctuation symbol(s) in the text-input area 302 (e.g., in the example of FIG. 3O, the ? symbol is then displayed in text-input area 302). If the device determines (311-Alphanumeric Key(s)) that the contact associated with the continuous-path gesture has travelled over one or more alphanumeric keys, then the device 100 displays (317) one or more alphanumeric character(s) in the text-input area 302. For example, as illustrated in FIGS. 3F-3I, the contact 330 associated with a continuous-path gesture moves over the “H,” “E,” “Y,” and “,” keys, and the device 100 displays this corresponding string in the text-input arca 302. In the text-input area 302, the characters could be displayed in light gray font during the continuous-path gesture 324, then in black font when the contact input is released.

References to “move over” in the sense of a continuous-path gesture moving over and selecting a particular keyboard key refers to a contact associated with the continuous-path gesture indicating a selection of the particular keyboard key, which selection can be indicated by the contact moving over the particular keyboard key and staying on top of that particular keyboard key for at least a threshold period of time (e.g., more than 0.0003 milliseconds, or some other appropriate time threshold to indicate a selection event) before the contact moves away from the particular keyboard key.

In some embodiments, after displaying one or more punctuation symbol(s), device 100 optionally displays (315) one or more whitespace character(s) (e.g., whitespace character 331, FIG. 3K) after each of the punctuation symbols (e.g., two whitespace characters after a period, or one whitespace character after a comma). In some embodiments, the method 300 is also executed by the device 100 in conjunction with execution of the method 400 described below and, therefore, after the device 100 displays either one or more punctuation symbol(s) or one or more alphanumeric character(s), the device 100 continues to perform (321) a method 400, which is illustrated in FIG. 4A. Finally, in some embodiments, the device 100 determines (319) whether the contact associated with the continuous-path gesture has lifted-off from the touch-sensitive display 112. If the device 100 determines that the contact has lifted-off from the touch-sensitive display 112 (319-Yes), then the method returns to monitoring for new contacts at the keyboard until another contact is detected at operation 301, and then the method 300 continues again. If no lift-off is detected at the determination 319 (319-No), then the device continues to monitor a path travelled by the contact associated with the continuous-path gesture (e.g., continues at operation 311 to detect which keys are selected during the continuous-path gesture), and outputs various symbols to a text-input area based on which alphanumeric and punctuation keys are selected during the continuous-path gesture.

FIGS. 3B-30 are diagrams of a user interface in which a continuous-path keyboard mode is utilized, in accordance with some embodiments. FIGS. 3B-3D illustrate a message user interface (e.g., a user interface used in conjunction with an application that allows for exchanging messages between users) in which the device 100 introduces the continuous-path keyboard mode to the user. In some embodiments, the message user interface includes a text-input area 302, an application button 304, a camera button 306, and a voice-input button 308. In some embodiments, when the user opens the message user interface, the device 100 displays an introduction user interface 310 overlaid on (or displayed in place of) a touch-sensitive keyboard. If the user selects “OK” button 312 (e.g., contact 316 as an input over the OK button 312, shown in FIG. 3C), then the introduction user interface 310 introduces the user to the continuous-path keyboard mode. In some embodiments, the introduction to the continuous-path keyboard feature is an animation 312 that shows a summarized example of a continuous-path gesture on a miniature version of a keyboard. If, on the other hand, the user selects “Dismiss” button 313, the introduction user interface 310 will disappear and the animation 312 will not be displayed.

FIGS. 3E and 3F illustrate the touch-sensitive keyboard 314 in a normal mode of operation in which tap inputs at the touch-sensitive keyboard 314 are used to actuate keys of the keyboard 312. In the illustrated example of FIG. 3F, device 100 detects a contact 323 at the “H” key. In response to this detection, the device 100 displays the “H” character in the text-input area 302 (in some embodiments, characters are displayed in the text-input area 302 in response to key-down events, e.g., when contact 323 makes contact with the “H” key, and, in other embodiments characters are displayed after key-up events (e.g., when contact 323 makes contact with the “H” key and then lifts-off from the “H” key)). In addition, device 100 displays word-completion options (e.g., options 322 shown in FIG. 3F), based on the characters that have been typed. The word-completion options 322 update as the user continues to type additional characters. In some embodiments, the word-completion options 322 could be completed words that are the most-common words beginning with the characters that the user has typed. In other embodiments, the word-completion options 322 could be the incomplete word that the user has typed. In other embodiments, the word-completion options 322 could be tailored to the user such that the options are based on the most-common words beginning with the text that that specific user has previously typed. In some embodiments, the user could select a word-completion option by continuing the continuous-path gesture 324, rather than lifting off from the touch-sensitive display 112. In this way, the continuous-path gesture 324 could extend outside the touch-sensitive keyboard 314. In some embodiments, the word completion options could be displayed in-line with characters displayed in the text-input area 302.

Once the device 100 determines that a continuous-path gesture is being used, as illustrated in FIGS. 3G-3I for the contact 323 that is travelling across the keyboard 314, the device 100 causes the keyboard to enter the continuous-path keyboard mode, and replaces one or more function keys with punctuation symbol keys (in some instances, a single function key is replaced with multiple punctuation keys), and lightens the boundaries around the keys of the touch-sensitive keyboard. In this way, as illustrated in FIG. 3I, the user is able to select punctuation keys during the continuous-path gesture, without having to interrupt the inputting of characters during the gesture to then navigate to a different screen and search for the desired punctuation symbol key. As illustrated in FIG. 3J, the device 100 detects that the user has lifted the contact input off of the touch-sensitive display 112, and can either remain in the continuous-path keyboard mode, or the device can immediately exit the continuous-path keyboard mode and return to displaying the function keys instead of the punctuation keys.

An example in which the device immediately exits the continuous-path keyboard mode is depicted in FIG. 3K, which illustrates that the function keys “123” and “return” are again displayed instead of the punctuation keys, and also shows that key boundaries are again displayed around the keys on the keyboard. In other embodiments, the continuous-path keyboard mode can remain for a short period of time (e.g., 500 milliseconds or less) after the end of a continuous-path gesture (e.g., when a contact associated with the gesture has lifted-off from the display). As shown in FIG. 3K, a user can touch type the “W” character (using a contact 328) while the keyboard is in the normal keyboard mode, and, after typing this “W” character, a whitespace character 331 can then be visible in the text-input area 302 (in some embodiments, the whitespace character 331 is added after the continuous-path gesture travels over the punctuation symbol “,” but this whitespace character 331 might not be visible until a new character is added to the text-input area 302).

FIG. 3L illustrates that a user is typing characters using a left-handed grip. In some embodiments, the device 100 detects a contact 330 over the “H” key. When the device detects contact 330, and determines that the user is typing using their left hand, then the device 100 displays the most commonly used punctuation symbol keys on the left-hand side of the touch-sensitive keyboard 314. In some embodiments, as illustrated in FIG. 3L, the “?” and “!” are the most commonly used punctuation symbols, and thus those keys are displayed on the left-hand side of the touch-sensitive keyboard 314 (determining which punctuation symbol keys are most commonly used can be performed by monitoring user interactions with the keyboard to determine which punctuation symbols the user types most often). As illustrated in FIGS. 3M-3O, the most commonly used punctuation symbol keys continue to be displayed throughout the continuous-path gesture whereby the user traces over characters on the keyboard to type the message, “Hey, what are you doing?”

FIG. 4A is a flowchart illustrating a method 400 of responding to a delete key gesture at a touch-sensitive keyboard (or a touch-sensitive delete key that can be displayed within a narrow rectangular OLED strip that is displayed above a physical keyboard, such as the TOUCH BAR® offered by APPLE Inc. of Cupertino, CA), in accordance with some embodiments. Referring to FIGS. 4A-4N, in some embodiments, while displaying a touch-sensitive keyboard (e.g., keyboard 314, FIG. 4B) on at least a portion of the touch-sensitive display 112, the device 100 detects (405) a first contact 403 at a touch-sensitive delete key 418. The touch-sensitive delete could be in a touch-sensitive keyboard or could be a delete key displayed within a touch bar, as was mentioned above.

In some embodiments, in response to the detection (405) and upon the key-down event occurring for the delete key, the device 100 deletes (407) a last character adjacent to a cursor 320 (e.g., the “u” character that was displayed in text-input area 302, of FIG. 4F is deleted upon detecting a key-down event caused by contact 403 over the delete key in FIG. 4G). In some embodiments, no cursor is displayed and the last character is identified as the last character added to the series of characters while a user is typing at the touch-sensitive keyboard 314. The series of characters displayed in the text-input area 302 may be added to the text-input area based on either a tap gesture or a continuous-path gesture.

In some embodiments, the device 100 determines (409) whether the first contact 403 swipes across the touch-sensitive delete key 418. If the device detects that the contact 403 swipes (e.g., swipe gesture 404 during which the contact 403 travels in a right-to-left direction that is substantially parallel to a bottom edge of the device 100, as shown in FIG. 4H for gesture 404) across the touch-sensitive delete key 418 (409-Yes), then the device 100 deletes (411) the remainder of the word that contained the deleted character adjacent to the cursor 320 (e.g., “yo” that was displayed in text-input area 302 of FIG. 4G is deleted in response to the swipe gesture 404 shown in FIG. 4H). In some embodiments, the device 100 optionally displays (413) a visual indicator 406 (e.g., highlighting or some other emphasizing effect) around the word that is next to the deleted word, which visual indicator alerts the user that the user can provide another swipe gesture to delete the word over which the visual indicator is displayed. In some embodiments, steps 411 and 413 are performed in a substantially simultaneous fashion, e.g., these two steps occur at the same time. In some embodiments, the device 100 detects (415) that the contact lifts off from the touch-sensitive display 112. In some embodiments, the device 100 then detects (417) a second contact (e.g., contact at the touch-sensitive delete key 418, and determines (419) whether the time since the first contact was detected is greater than a predetermined threshold (e.g., 0.0001, 0.0002, or 0.00025 milliseconds (ms)). If the time since the first contact was detected is greater than the predetermined threshold (419-Yes), then the device 100 deletes (421) a single character (e.g., the “t” character is deleted in FIG. 4J because the second contact 410 is determined to have occurred outside of the predetermined threshold (the second contact 410 was received 150 ns, or 0.00015 ms, after the first contact 403)). If, on the other hand, the second contact occurs within a period of time that is less than the predetermined threshold (419-No), then the device 100 deletes (423) a full word and forgoes doing a single character deletion (e.g., the word “what,” is deleted in full in FIG. 4K because the contact associated with swipe gesture 405 is received within 75 ns, or 0.000075 ms, which is less than the example predetermined threshold of 100 ns in this example). Upon lift-off of the contact (439), the method 400 returns to 405 to continue monitoring for new contacts at the delete key.

Returning back to the discussion of determination operation 409 in FIG. 4A, performance of the method 400 can also include monitoring for other types of gestures (besides swipe gestures) on the delete key. For instance, after determining that a swipe gesture has not been detected (409-No), at operation 425, the device 100 monitors for whether an extended contact is received over the delete key. At operation 425, the device 100 determines (425) whether the contact remains in contact with the touch-sensitive delete-key 418 for an extended duration (e.g., at least 300 ns, or 0.0003 ms). As a contact remains over the delete key for various extended-contact durations (each of duration may be 300 ns, or 0.0003 ms, or some other suitable time duration), then different character sets are deleted (e.g., a full word for a first extended-contact duration at operation 427; a full sentence for a second extended-contact duration at operation 433; and a full paragraph for a third extended-contact duration at operation 437). If the contact remains in contact with the touch-sensitive delete key 418 for a first extended-contact duration (425-Yes), then the device 100 deletes (427) an entire word (e.g., the word “doing,” FIGS. 4B-4E), otherwise (425-No) the device 100 deletes (429) a single character (e.g., single-character deletions of characters “?,” “g,” and “n” are shown in FIGS. 4B-4D). In some embodiments, the device 100 determines (431) whether the contact remains in contact with the touch-sensitive delete key 418 for a second extended-contact duration. If the contact remains in contact with the touch-sensitive delete key 418 for the second extended-contact duration (431-Yes), then the device 100 deletes (433) an entire sentence. In some embodiments, the device 100 determines (435) whether the contact input 402 remains in contact with the touch-sensitive delete key 418 for third extended-contact duration. If the contact remains in contact with the touch-sensitive delete key for this third extended-contact duration (435-Yes), then the device 100 deletes (437) an entire paragraph. If, on the other hand, at any of steps 425, 431, or 435, the device 100 determines that the contact does not remain in contact with the touch-sensitive delete key 418 for any of these extended-contact durations, then the device 100 returns to operation 405 to continue monitor for new contacts at the touch-sensitive delete key.

FIGS. 4B-4N are diagrams of a user interface in which a delete key gesture is performed, in accordance with some embodiments. As illustrated in FIG. 4B, in some embodiments, the device 100 detects a contact at the touch-sensitive delete key 418 (e.g., contact 402). In response to this detection (and based on having detected such a key-down event), the device 100 deletes the “?” symbol from the text-input area 302 (which was previously displayed as shown in FIG. 30). In some embodiments, the contact 402 remains in contact with the touch-sensitive delete key 418 for an extended-contact duration, as illustrated by the timer in FIGS. 4C-4E. If this duration satisfies a predetermined threshold (e.g., 300 ns, or 0.0003 ms), then device 100 performs a word-by-word deletion, rather than a character-by-character deletion. This is illustrated in FIGS. 4C-4E by deletion of the string “doing” from the text-input area 302. Then, as illustrated in FIG. 4F, the device 100 detects that the contact 402 lifts off from the touch-sensitive delete key 418.

FIG. 4G illustrates that the device 100 detects another contact 403 at the touch-sensitive delete key 418. In response to this detection (and based on having registered a key-down event over the touch-sensitive delete key), the device 100 deletes the character “u” from the text-input area 302. In some embodiments, as illustrated in FIG. 4H, the device 100 then detects that the contact 403 moves in a right-to-left direction across the touch-sensitive delete key (this horizontal movement of the contact 403 forms a swipe gesture across the touch-sensitive delete key). In response to the swipe gesture over the touch-sensitive delete key, the device 100 deletes the remaining characters in the word “you” (“yo”) from the text-input area 302. Substantially simultaneously, the device 100 displays a visual indicator 406 around the next word “are,” thus indicating to the user that if the user performs another swipe gesture, the word “are” will be deleted.

FIG. 4I illustrates movement of an additional contact 482 across the touch-sensitive delete key (forming an additional swipe gesture) that was performed 50 nanoseconds (or 0.00005 milliseconds) since the last contact 403 had lifted-off from the touch-sensitive delete key 418, as illustrated by the illustrated timer in FIG. 41. In response to determining that the additional swipe gesture was performed within 50 nanoseconds of the last contact 403, the device 100 deletes the word “are” from the text-input area 302 because 50 nanoseconds is less than the predetermined threshold for determining whether to delete individual characters or words (e.g., 100 ns, or 0.0001 milliseconds). On the other hand, if the device 100 instead detects a new contact (e.g., contact input 410, FIG. 4J) that is performed at a time which is greater than the predetermined threshold (e.g., 150 ns, shown in the timer of FIG. 4J), then the device 100 only deletes a single character (e.g., “t,” FIG. 4J) and does not display visual indicator 406 in the text-input area 302. However, as illustrated in FIG. 4K, in some embodiments the device 100 then detects a swipe gesture 404. In response to detecting swipe gesture 404, the device 100 deletes remaining characters of a word (e.g., the remaining characters “wha” from the word “what”) and displays the visual indicator 406 around the word “Hey,” in text-input arca 302.

FIGS. 4L-4N illustrate that in some embodiments, the process described above is performed in response to a swipe gesture across the touch-sensitive delete key 418 that moves from left to right. In this way, the left-to-right swipe gesture deletes words to the right of the cursor 320. As illustrated in FIG. 4L, the device 100 detects a contact 412 at the beginning of the string of characters that is displayed in the text-input area 302. In response to contact input 412, the device 100 positions the cursor 320 at the beginning of the string of characters. As illustrated in FIG. 4M, the device 100 then detects a contact 414 at the touch-sensitive delete key 418. However, the device 100 does not perform a deletion here because there are no characters located to the left of the cursor 320 in the text-input area 302. As illustrated in FIG. 4N, the device 100 then detects a contact 416 followed by movement of that contact forming a swipe gesture across the touch-sensitive delete key 418 that moves in a left-to-right direction that is parallel to a bottom edge of the device 100. In response to detecting the swipe gesture formed by movement of contact 416, the device 100 deletes the word adjacent to the cursor 320 in a rightward direction (e.g., “Hey,”). Substantially simultaneously, the device 100 displays the visual indicator 406 around the next string “wha” located to the right of the word that was deleted, thus indicating to the user that if the user performs another swipe gesture from left to right, the word “wha” may be deleted.

FIGS. 5A-5D are flowcharts illustrating a method 500 of adding a punctuation symbol key to a touch-sensitive keyboard, in accordance with some embodiments. FIGS. 3B-3O are used to illustrate the methods and/or processes of FIGS. 5A-5D. Although some of the examples which follow will be given with reference to inputs on a touch-sensitive display (in which a touch-sensitive surface and a display are combined), in some embodiments, the device detects inputs on a touch-sensitive surface 195 that is separate from the display 194, as shown in FIG. 1D. Certain operations described with reference to FIG. 3A can also or alternatively be performed in conjunction with the operations of method 500

In some embodiments, the method 500 is performed by an electronic device (e.g., portable multifunction device 100, FIG. 1A) and/or one or more components of the electronic device (e.g., I/O subsystem 106, operating system 126, etc.). In some embodiments, the method 500 is governed by instructions that are stored in a non-transitory computer-readable storage medium and that are executed by one or more processors of a device, such as the one or more processors 122 of device 100 (FIG. 1A). For case of explanation, the following describes method 500 as performed by the device 100. In some embodiments, with reference to FIG. 1A, the operations of method 500 are performed by or use, at least in part, continuous-path gesture module 163-1, delete gesture module 163-2, and touch-sensitive display 112. Some operations in method 500 are, optionally, combined and/or the order of some operations is, optionally, changed. As described below, the method 500 provides improved typing efficiency at touch-sensitive keyboards. By improving typing efficiency, method 500 helps to such methods and interfaces help to enhance the operability of the electronic device and make the human-machine interface more efficient (e.g., by allowing the user to type punctuation symbols during a continuous-path gesture without having to tap the function key and search for the desired punctuation symbol) which, additionally, reduces power usage and improves battery life of the device by enabling the user to spend less time using the touch-sensitive keyboard.

In some embodiments, the method 500 is a method of adding (502) a punctuation symbol key to a touch-sensitive keyboard, and the method is performed (504) at an electronic device that includes a display and a touch-sensitive keyboard. In some embodiments, the electronic device could be a laptop with a display where a keyboard used to be or a mobile device like a tablet or phone. An example of such a method carried out at portable multifunction device 100 that includes a touch-sensitive display 112 and touch-sensitive keyboard 314 is illustrated in FIGS. 3B-3O.

In some embodiments, the method 500 further includes: displaying (506) a plurality of keys on the touch-sensitive keyboard. FIG. 3E illustrates an example plurality of keys on the touch-sensitive keyboard 314. In some embodiments, the touch-sensitive keyboard could display alphanumeric keys of a QWERTY keyboard and one or more function keys (e.g., return key, emoji key, microphone key, and other function keys).

In some embodiments, the method 500 also includes: in response to a continuous-path gesture on the touch-sensitive keyboard in which a contact associated with the continuous-path gesture travels over two or more of the plurality of keys (e.g., without a lift-off of the contact during the continuous-path gesture): begin displaying (508) a punctuation symbol key on the touch-sensitive keyboard; and displaying (508), in a text-input area on the display, one or more characters (e.g., in light gray font during the continuous-path gesture, then in black font when the contact is released) based on respective keys contacted by the contact during the continuous-path gesture. In some embodiments, the punctuation symbol key replaces one or more function keys.

An example continuous-path gesture is shown in FIGS. 3F-3I, in which the continuous-path gesture 324 moves over and selects (e.g., actuates by remaining over each key for a certain predetermined amount of time such as 0.0001 ms during the continuous-path gesture) keys “H,” “E,” “Y,” and “,” thereby tracing out the word “Hey,”. The continuous-path keyboard could be turned on and off in a settings user interface of the device 100. In some embodiments, if the continuous-path keyboard is turned on, then an animation (e.g., animation 312, FIG. 3D) is displayed when the user opens an application that makes use of a touch-sensitive keyboard, such as a messaging application. This animation provides a brief introduction to the continuous-path keyboard by, for example, tracing an example continuous-path gesture on a miniature version of a keyboard that is displayed in place of the touch-sensitive keyboard (e.g., as shown in FIG. 3D). In some embodiments, if this animation has been shown to the user on one device, then the animation will not be shown to that user on other devices that make use of the continuous-path keyboard (e.g., if a user views the brief introduction on a first device such as a mobile phone, then the user would not then be presented with the brief introduction on another device associated with that user such as a tablet electronic device).

In some embodiments, displaying of the punctuation symbol key includes ceasing (512) to display a respective key (e.g., return key, “123” key, emoji key, etc.) of the plurality of keys on the touch-sensitive keyboard. In some embodiments, the displaying of the punctuation symbol key includes displaying (514) an additional punctuation symbol key on the touch-sensitive keyboard that can be displayed adjacent to the punctuation symbol key (in other words two punctuation symbol keys are both displayed as part of the keyboard 314 upon detecting the continuous-path gesture on the keyboard 314). In some embodiments, the punctuation symbol key and the additional punctuation symbol key are displayed (514) in an area of the touch-sensitive keyboard that was previously used to display only one respective key of the plurality of keys, such as a return function key (e.g., as depicted in FIG. 3G, punctuation keys “.” and “,” are displayed in an area of the keyboard 314 that was previously used to display the return function key). In some embodiments, the punctuation symbol key and the additional punctuation symbol key are the two most-used punctuation symbol keys (e.g., “?” and “!”), and are displayed in an area where the number key was previously displayed. In some embodiments, less-used punctuation keys (e.g., “.” and “.”) are displayed in an area where a one or more different function keys were previously displayed. A determination of most-used and less-used punctuation keys can be based on the user's prior interactions with the keyboard 314.

In some embodiments, an arrangement of the punctuation symbol key and the additional punctuation key is determined (516) based on whether the continuous-path gesture is provided using a user's left or right hand. In some embodiments, when a user types with the left hand, the most-used punctuation symbol keys are displayed closer to the user's left hand and less-used punctuation symbol keys are displayed further away from the user's left hand on the touch-sensitive keyboard. When a user types with the right hand, the most-used punctuation symbol keys are displayed closer to the user's right hand and less-used punctuation symbol keys are displayed further away from the user's right hand on the touch-sensitive keyboard.

In some embodiments, the respective key of the plurality of keys is a function key (e.g., “123” function key, return function key, emoji function key, etc.) that, when selected, causes display (518) of additional functionality (or causes activation of a keyboard function other than outputting an alphanumeric symbol) associated with the touch-sensitive keyboard. For example in FIG. 3G, upon detecting that the contact 323 is forming a continuous-path gesture as it moves from the “H” key to the “E” key, the return function key is no longer displayed and punctuation symbol keys for “.” and “,” are displayed instead. As FIG. 3G also shows, a number of punctuation symbol keys can be added to the keyboard 314 upon detection of the continuous-path gesture, such as 2 or 3 or 4 punctuation symbol keys. In some embodiments, the method 500 further includes: after the contact associated with the continuous-path gesture has lifted off from the touch-sensitive display, begin displaying (520) the function key and cease to display the punctuation symbol key. For example, after detecting a lift-off of the contact 323 in FIG. 31, the device may then return to displaying the keyboard 314 in a normal mode of operation, including displaying the function keys, as is depicted in FIG. 3E. In some embodiments, the user may exit a continuous-path gesture mode and enter a normal keyboard mode by lifting off from the touch-sensitive display. In this way, the user can easily navigate between modes of a keyboard 314 while using a single same application.

In some embodiments, the method 500 further includes: after the displaying of the punctuation symbol key: in response to the contact associated with the continuous-path gesture travelling over the punctuation symbol key, displaying (522), in the text-input area on the display, a punctuation symbol associated with the punctuation symbol key. In this way, users do not need to cease providing a continuous-path gesture in order to select punctuation keys; instead, users can simply select the punctuation symbol keys during the continuous-path gesture in one fluid motion, thereby improving their interactions with the device 100, and avoiding wasteful inputs and interruptions of a sustained interaction with the device 100. In some embodiments, displaying the punctuation symbol in the text-input area includes displaying (524), automatically without human intervention, a whitespace character (e.g., whitespace character 331, FIG. 3K) adjacent to the punctuation symbol in the text-input area. Stated another way, the device 100 adds a whitespace character after the punctuation symbol to avoid forcing the user to add the whitespace character manually and, in this way, users save time and are able to provide more fluid continuous-path gestures that need not be interrupted to perform selections of whitespace characters.

In some embodiments, the method 500 further includes: during the continuous-path gesture, displaying (526) (e.g., between the text-input area and the touch-sensitive keyboard, or within the text-input area) two or more selectable word-completion options (e.g., auto-correct options) (e.g., word-completion options 322, FIG. 31) based on characters over which the contact associated with the continuous-path gesture has travelled. In some embodiments, the word-completion options could be completed words that are the most-common words beginning with the text that the user has typed. In some embodiments, a word-completion option could be the incomplete word that the user has typed. In other embodiments, the word-completion options could be tailored to the user such that the options are based on the most-common words beginning with the text that that specific user has previously typed. The word-completion options update as more characters are typed and displayed in the text-input area.

In some embodiments, the two or more selectable word-completion options displayed during the continuous-path gesture are displayed (528) directly above the touch-sensitive keyboard on the display. In some embodiments, the user could select a word-completion option by continuing the continuous-path gesture, rather than lifting off from the touch-sensitive display. In this way, the continuous-path gesture could extend outside the touch-sensitive keyboard. In some embodiments, the two or more word completion options displayed during the continuous-path gesture are displayed (530) in the text-input arca. In some embodiments, the auto-correct options could be displayed in-line with characters displayed in the text-input area on the touch-sensitive display.

In some embodiments, the method 500 further includes: while the contact associated with the continuous-path gesture travels across the touch-sensitive keyboard, displaying (532) a visual indicator (e.g., a snake-like animation that could illustrate a color fading effect from one end of the animation to another) reflecting a path followed by the continuous-path gesture, the path indicating a predetermined number of keys (e.g., 2, 3, 4, 5, or 6) over which the continuous-path gesture has travelled (e.g., example snake-like animations 324 are shown in FIGS. 3G-3I). The continuous-path gesture could additionally or alternatively invoke other visual indicators besides the snake-like animation. For example, in some embodiments the boundaries around the keys of the touch-sensitive keyboard could be removed and/or lightened (FIGS. 3G-3I and 3M-3O). In some embodiments, the keys could be highlighted, could be lit-up, or could change color or size based on a path followed by the continuous-path gesture. In some embodiments, the indicator has (534) a greatest line width closer to the contact associated with the continuous-path gesture (e.g., the most recent contact) and a gradually decreasing line width farther away from the contact (e.g., a less recent contact in the continuous-path gesture than the current contact).

It should be understood that the particular order in which the operations in FIGS. 5A-5D have been described is merely one example and is not intended to indicate that the described order is the only order in which the operations could be performed. One of ordinary skill in the art would recognize various ways to reorder the operations described herein, such as by incorporating some of the operations described with reference to FIG. 3A above.

FIGS. 6A-6C and 7 are flowcharts illustrating methods of responding to different gestures on a touch-sensitive delete key, in accordance with some embodiments. FIGS. 4B-4N are used to illustrate the methods and/or processes of FIGS. 6A-6C and 7. Although some of the examples which follow will be given with reference to inputs on a touch-sensitive display (in which a touch-sensitive surface and a display are combined), in some embodiments, the device detects inputs on a touch-sensitive surface 195 that is separate from the display 194, as shown in FIG. 1D.

In some embodiments, methods 600 and 700 are performed by an electronic device (e.g., portable multifunction device 100, FIG. 1A) and/or one or more components of the electronic device (e.g., I/O subsystem 106, operating system 126, etc.). In some embodiments, the methods 600 and 700 are governed by instructions that are stored in a non-transitory computer-readable storage medium and that are executed by one or more processors of a device, such as the one or more processors 122 of device 100 (FIG. 1A). For ease of explanation, the following describes methods 600 and 700 as performed by the device 100. In some embodiments, with reference to FIG. 1A, the operations of methods 600 and 700 are performed by or use, at least in part, continuous-path gesture module 163-1, delete gesture module 163-2, and touch-sensitive display 112. Some operations in methods 600 and 700 are, optionally, combined and/or the order of some operations is, optionally, changed. As described below, the methods 600 and 700 provide improved typing efficiency at touch-sensitive keyboards. By improving typing efficiency, methods 600 and 700 help to enhance the operability of the electronic device and make the human-machine interface more efficient (e.g., by allowing the user to type punctuation symbols during a continuous-path gesture without having to tap the function key and search for the desired punctuation symbol) which, additionally, reduces power usage and improves battery life of the device by enabling the user to spend less time using the touch-sensitive keyboard. Operations of the methods 600 and 700 can be combined or exchanged with operations of the method 400 described above.

In some embodiments, the method 600 is a method of responding (602) to different gestures on a touch-sensitive delete key. In some embodiments, the method 600 includes: performing (604) the method at an electronic device that includes a display and a touch-sensitive delete key. In some embodiments, the touch-sensitive delete key could be displayed as part of a touch-sensitive keyboard that is displayed on the device 100 or could be a delete key displayed within a narrow rectangular OLED display that is above a physical keyboard (e.g., a keyboard with mechanically-actuatable keys that is below the narrow rectangular OLED display, such as the TOUCH BAR® offered by APPLE Inc. of Cupertino, CA) of an electronic device.

In some embodiments, the method 600 further includes: displaying (606) a series of characters and a cursor after a last character of the series of characters in a text-input arca on the display. A series of characters can include alphanumeric symbols, punctuation symbols, and/or other symbols (such as emojis), where the symbols of the series of characters do not include a whitespace character. For example, the series of characters can be a dictionary word (such as the word “doing” displayed within text-input arca 302 of FIG. 4B). In some embodiments, the method 600 further includes: in response to a tap gesture on the touch-sensitive delete key, deleting (608) the last character of the series of characters from the text-input arca and continuing to display a remainder of the series of characters in the text-input area. In some embodiments, a cursor (e.g., cursor 320, FIG. 4B) is moved to a character that is next to the deleted last character. In some embodiments, no cursor is displayed and the last character is identified as the last character added to the series of characters while a user is typing at a keyboard. In some embodiments, the method 600 further includes: in response to a swipe gesture on the touch-sensitive delete key, deleting (610) the remainder of the series of characters from the text-input area. The swipe gesture could move in a right-to-left direction across the touch-sensitive delete key (which deletes to the left of the cursor, an example of which is shown in FIGS. 4G-4H, where the characters “yo” are deleted to the left of the cursor 320 after the swipe gesture formed by contact 403) or move in a left-to-right direction across the touch-sensitive delete key (which deletes to the right of the cursor, an example of which is shown in FIGS. 4M-4N, where the characters “Hey,” are deleted in response to left-to-right swiping movement of contact 416).

In some embodiments, the method 600 further includes: after deleting the remainder of the series of characters from the text-input area, the device continues (612) to display in the text-input area a second series of characters (e.g., second series of characters “are”; third series of characters “what”; and fourth series of characters “Hey” all continue to be displayed in the text-input area 302 of FIG. 4H, after the remainder of the first series of characters “you” was deleted). A second series of characters can include alphanumeric symbols, punctuation symbols, and/or other symbols (such as emojis), where the symbols of the second series of characters do not include a whitespace character. For example, the series of characters can be a dictionary word.

In some embodiments, the method 600 further includes: in response to a new swipe gesture (e.g., swiping gesture formed by contact 403, FIG. 4H, as it moves across the touch-sensitive delete key) on the touch-sensitive delete key, deleting (612) the second series of characters from the text-input area (e.g., after swiping gesture formed by contact 403 in FIG. 4H, the second series of characters “are” is deleted from the text-input arca 302 in FIG. 4I).

In some embodiments, the new swipe gesture is received (614) within a predetermined amount of time after a lift-off of a contact associated with the swipe gesture. In some embodiments, deleting the second series of characters includes deleting (614) the second series of characters at a same time, and without doing any character-by-character deletion of characters in the second series of characters. In other words, in some embodiments, there is no character-by-character deletion. Instead, all characters in the second series of characters (e.g., characters “are” shown in FIG. 4H, and deleted in FIG. 41) are deleted together at the same time such that they are no longer displayed on the display. In this way, a first swipe gesture can proceed with deleting one character upon a key-down event by a contact associated with the first swipe gesture (e.g., key-down event in FIG. 4G caused by contact 403 over the delete key causes deletion of the “u” character from the first series of characters “you”), followed by deleting a remainder of the characters once the swiping gesture formed by the contact 403 is detected (e.g., in FIG. 4H swiping movement of contact 403 causes deletion of the remainder of the characters “yo”). The new swipe gesture can allow for deleting all of the second series of characters without having any character-by-character delete operations at all. The predetermined amount of time can be 0.0005 milliseconds or less (e.g., 0.0003 milliseconds), or some other appropriate time-based threshold to ensure that the new swipe gesture is received very shortly after the swipe gesture, thus evidencing the user's intent to perform a word-by-word deletion gesture.

In some embodiments, the method 600 further includes: before deleting the second series of characters (e.g., “are” in FIG. 4H), displaying (620) a visual indicator (e.g., highlighting or some other emphasizing effect 406 depicted in FIG. 4H around the second series of characters “are”) around the second series of characters to provide an indication that the second series of characters would be deleted from the text-input area after a new swipe gesture on the touch-sensitive delete key.

In some embodiments, after deleting the second series of characters, the device continues to display (616) a third series of characters in the text-input area (e.g., third series of characters “what”; and fourth series of characters “Hey” all continue to be displayed in the text-input area 302 of FIG. 4I, after the first and second series of characters have been deleted). A third series of characters can include alphanumeric symbols, punctuation symbols, and/or other symbols (such as emojis), where the symbols of the third series of characters do not include a whitespace character. For example, the series of characters can be a dictionary word.

In some embodiments, the method 600 further includes: in response to an additional swipe gesture on the touch-sensitive delete key that is received after the predetermined amount of time (e.g., the time threshold of 0.0003 or 0.0005 ms discussed above) from a lift-off of a contact associated with the new swipe gesture, deleting (618) one character of the third series of characters from the text-input area before deleting a remainder of the third series of characters from the text-input area. In other words, in some embodiments, if after a predetermined amount of time from a lift-off, the user contacts the delete key again, then the electronic device performs a single character deletion before performing deletion of a remainder of a word based on a swiping gesture of that contact.

In some embodiments, the method 600 further includes: in response to a press-and-hold gesture on the touch-sensitive delete key, deleting (622) two or more separate series of characters from the text-input area, wherein the two or more separate series of characters are deleted from the text-input area at different points in time. In some embodiments, this feature helps users acclimate to a word-by-word deletion operation by ensuring that words are deleted one after another (instead of having all words cease to be displayed at once), for consistency with experiences with character-by-character delete operations that are performed such that each character is deleted at a different point in time in response to a press-and-hold gesture.

In some embodiments, the word-by-word deletion described here performs word deletions by separating cach delete operation by a longer period of time than that used to delete individual characters in character-by-character deletion implementations (e.g., 0.0005 milliseconds of time for separation of word-by-word deletion operations, as compared to 0.0003 milliseconds of separation for character-by-character deletion in other implementations). In some embodiments, the press-and-hold gesture includes a contact on the touch-sensitive delete key that remains over the key for some threshold amount of time (e.g., 500 milliseconds, 600 milliseconds) for performing a word-by-word deletion, a higher threshold amount of time for performing a sentence-by-sentence deletion, and an even higher threshold amount of time for a paragraph-by-paragraph deletion. In some embodiments, the press-and-hold gesture includes a contact on the touch-sensitive delete key that remains over the key for some threshold amount of character deletions (e.g., 20 characters).

In some embodiments, the touch-sensitive delete key is displayed (626) on a touch-sensitive keyboard on the display.

In some embodiments, the series of characters and the second series of characters were added to the text-input area based on (632) a continuous-path gesture in which a continuous contact moves across multiple keys of a touch-sensitive keyboard. An example continuous-path gesture is shown in FIGS. 3F-3I, in which the continuous-path gesture 324 moves over keys “H,” “E,” “Y,” and “,” thereby tracing out the word “Hey,”. In some embodiments, the delete key can be selected during the continuous-path gesture, thereby deleting characters that were previously selected during that continuous-path gesture. In some embodiments, the series of characters and the second series of characters were added to the text-input arca based on (634) tap gestures over respective keys of a touch-sensitive keyboard. In some embodiments, the series of characters and the second series of characters can be added to the text-input area based on either a tap gesture or a continuous-path gesture.

In some embodiments, the method 600 can also include a determination as to which type of gesture is received over the delete key, and an example of such a determination is described below with reference to method 700 of FIG. 7. In some embodiments, the method 700 includes: displaying (702) a series of characters and a cursor after a last character of the series of characters in a text-input area on the display. A series of characters can include alphanumeric symbols, punctuation symbols, and/or other symbols (such as emojis), where the symbols of the series of characters do not include a whitespace character. For example, the series of characters can be a dictionary word. In some embodiments, the method 700 further includes: detecting (704) a gesture on the touch-sensitive delete key. The gesture could be either a tap gesture or a swipe gesture. The swipe gesture could be from right-to-left (which deletes to the left of the cursor) or left-to-right (which deletes to the right of the cursor). In some embodiments, the method 700 further includes: determining (706) whether the gesture is of a first gesture type or a second gesture type different from the first gesture type. The first and second gesture types could be either a tap gesture type or a swipe gesture type, so long as the two gesture types are different from one another.

In some embodiments, the method 700 further includes: upon determining that the gesture is of the first gesture type, performing (708) a first delete function on at least one of the series of characters adjacent the cursor. In one example, the first delete function is a single character deletion operation in which one character is deleted in response to the gesture being of the first gesture type that can be a tap gesture.

In some embodiments, the method 700 further includes: upon determining that the gesture is of the second gesture type (e.g., a swiping gesture), performing (710) a second delete function on at least one of the series of characters adjacent the cursor, wherein the second delete function is different than the first delete function. In one example, the second delete function is a word deletion operation in which characters associated with a word are all deleted at a same point in time.

It should be understood that the particular order in which the operations in FIGS. 6A-6C and 7 have been described is merely exemplary and is not intended to indicate that the described order is the only order in which the operations could be performed. One of ordinary skill in the art would recognize various ways to reorder the operations described herein.

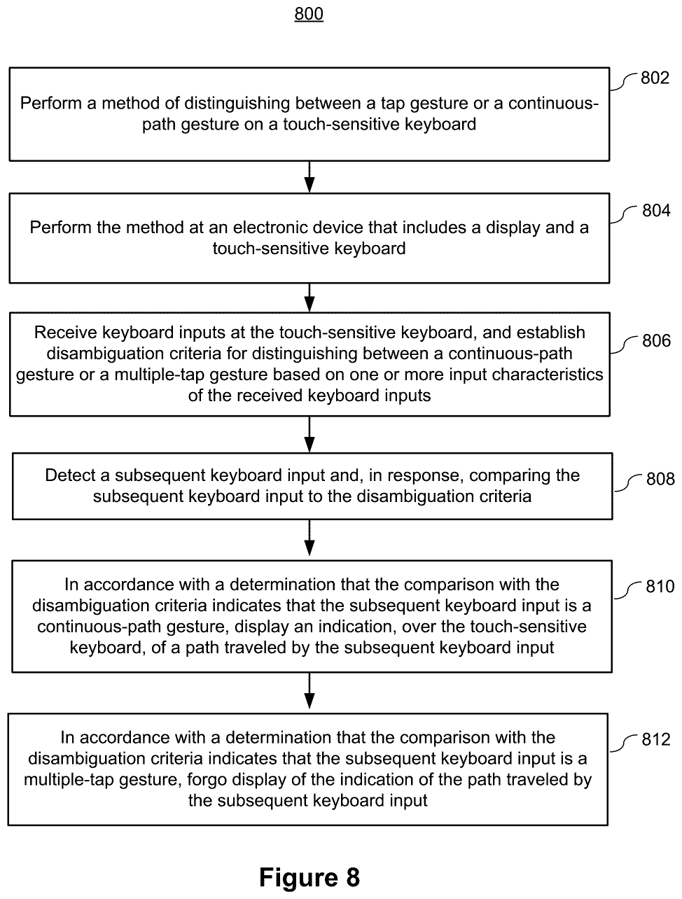

FIG. 8 is a flowchart illustrating a method of distinguishing between a tap gesture or a continuous-path gesture on a touch-sensitive keyboard, in accordance with some embodiments. In some embodiments, a method 800 includes: performing (802) a method of distinguishing between a tap gesture or a continuous-path gesture on a touch-sensitive keyboard, and performing (804) the method at an electronic device (e.g., portable multifunction device 100, FIG. 1A) that includes a display (e.g., touch-sensitive display 112, FIG. 1C) and a touch-sensitive keyboard (e.g., touch-sensitive keyboard 314, FIG. 3E). In some embodiments, the method 800 further includes: receiving (806) keyboard inputs at the touch-sensitive keyboard, and establishing (806) disambiguation criteria for distinguishing between a continuous-path gesture or a multiple-tap gesture based on one or more input characteristics (e.g., a swipe characteristic in which the keyboard input is a tap combined with a swipe across the touch-sensitive keyboard) of the received keyboard inputs.

In some embodiments, the method 800 further includes: detecting (808) a subsequent keyboard input (e.g., a continuous-path gesture or a tap gesture) and, in response, comparing (808) the subsequent keyboard input to the disambiguation criteria. In some embodiments, the method 800 further includes: in accordance with a determination that the comparison with the disambiguation criteria indicates that the subsequent keyboard input is a continuous-path gesture, displaying (810) an indication (e.g., a snake-like animation that could illustrate a color fading effect from one end of the animation to another), over the touch-sensitive keyboard, of a path traveled by the subsequent keyboard input. The continuous-path gesture could also invoke visual indicators in addition to the snake-like animation. For example, in some embodiments the boundaries around the keys of the touch-sensitive keyboard could be removed and/or lightened (FIGS. 3G-3I and 3M-3O). In some embodiments, the keys could be highlighted, could be lit-up, or could change color or size based on a path followed by the continuous-path gesture. In some embodiments, the method 800 further includes: in accordance with a determination that the comparison with the disambiguation criteria indicates that the subsequent keyboard input is a multiple-tap gesture, forgoing (812) display of the indication of the path traveled by the subsequent keyboard input. In some embodiments, this could be referred to as a normal keyboard mode.

In some embodiments, a tap gesture could trigger false detection of a continuous-path gesture if a user accidentally moves a contact across a touch-sensitive display while performing the tap gesture. In some embodiments, if a device (e.g., portable multifunction device 100, FIG. 1A) detects a contact moving across a touch-sensitive display (e.g., touch-sensitive display 112, FIG. 1A) for a distance that is greater than a predetermined maximum threshold distance lₘₐₓ (e.g., 5 millimeters (mm)), then the device activates a continuous-path gesture mode (e.g., a mode in which a continuous-path gesture at a touch-sensitive keyboard is used to spell out (trace out) words). However, if the distance travelled by the contact is less than a predetermined minimum threshold distance lₘᵢₙ (e.g., 1 mm), then the device does not activate the continuous-path keyboard mode, and remains in a tap gesture mode (e.g., a mode in which taps inputs are utilized at a touch-sensitive keyboard to spell out words). In this way, a short drag of the contact input will not invoke the continuous-path gesture mode because the device will have determined that the intended gesture was a tap gesture.

In some embodiments, the device may detect that the user dragged a contact across the touch-sensitive display for a distance that is between Imin and Imax. In such instances, the device will determine whether to activate the continuous-path keyboard mode based on a recent history of detected gestures (e.g., the 3 most recent gestures). For example, if the recent history of gestures includes all continuous-path gestures (e.g., between keys on a touch-sensitive keyboard), then the device could activate the continuous-path gesture mode if the distance travelled by the contact is a value between lₘᵢₙ and lₘₐₓ. On the other hand, if the most recent history of gestures includes all tap gestures, then the device could forego activating the continuous-path keyboard mode, and continue operating the keyboard in its normal mode. In some embodiments, the device detects an input at a time to and a position (x₀, y₀) on the touch-sensitive display. In response to this detection, the device begins executing a process for determining whether a tap gesture or a continuous-path gesture has been performed. If the device detects that the contact moves across the touch-sensitive display, then the device stores later positions of the contact at different points in time so that the device can compute the cumulative distance travelled across the touch-sensitive display.

In some embodiments, when the device 100 determines whether the disambiguation criteria discussed above are satisfied (e.g., operations 810 and 812), the device 100 can utilize a method of distinguishing between a tap gesture or a continuous-path gesture using the example routine depicted in the pseudocode below. The example routine may be used to code instructions that are stored in a non-transitory computer-readable medium (in memory 102, FIG. 1A) and executed by one or more processors (e.g., processor(s) 122) of the device 100. In the following routine, variables are defined as follows: telock is a clock time at which a last contact is detected, I is a current length of a detected continuous-path gesture, T is a recent tendency to use a tap gesture, P is a recent tendency to use a continuous-path gesture, (x,y)ₗₐₛₜ is the last position on the touch-sensitive display that the device has detected a contact, and pathActive is a binary value representing whether the device has detected a continuous-path gesture. Finally, nₓ, n_{y}, T₀, and P₀ are predetermined constants. A person of skill in the art will appreciate that this routine is just one example of how disambiguating between tap and continuous-path gestures can be performed, and that various additions, modifications, and substitutions to this routine are within the scope of this disclosure.

```
handleTouchEvent (x, y, t, stage)
  t_{clock} = 0;
  l = 0;
  T = 0;
  P = 0;
  (x, y)ₗₐₛₜ = (0, 0);
  d = zeros;
  pathActive = false;
  T = T * exp(−d(t − t_{clock}));
  P = P * exp(−d(t − t_{clock}));
  t_{clock} = t;
  if stage down
    l = 0;
  end
  if stage drag
    l = 0;
    $l = l + \sqrt{{( \frac{y - {y}_{last}}{{n}_{y}} )}^{2} + {( \frac{x - {x}_{last}}{{n}_{x}} )}^{2}} ;$
    activationLength = lₘᵢₙ + lₘₐₓ;
    if l > activationLength
      pathActive = true;
    end
  end
  if stage up
    if pathActive = true
      P = P + 1;
    end
  else
    T = T + 1;
    pathActive = false;
  end
  return
    $activationLength = {l}_{min} ( \frac{{P}_{0} + P}{{T}_{0} + T + {P}_{0} + P} ) + {l}_{max} ( \frac{{T}_{0} + T}{{T}_{0} + T + {P}_{0} + P} )$
```

The operations in the information processing methods described above are, optionally implemented by running one or more functional modules in information processing apparatuses such as general purpose processors (e.g., as described above with respect to FIG. 1A) or application specific chips. The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from specific and legitimate sources to improve typing efficiency at a touch-sensitive keyboard. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used to allow users to more efficiently type punctuation symbols during a continuous-path gesture, and to delete strings of characters. Accordingly, use of such personal information data enables users to have greater control of typing at a touch-sensitive keyboard.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to turn on and off the collection of personal information data in a settings user interface. In addition, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users based on aggregated non-personal information data or a bare minimum amount of personal information, such as the content being handled only on the user's device or other non-personal information available to the content delivery services.

What is claimed is:

1. A method of responding to different gestures on a touch-sensitive delete key, the method comprising:
at an electronic device that includes a display and a touch-sensitive delete key:
displaying a series of characters and a cursor after a last character of the series of characters in a text-input area on the display;
in response to a tap gesture on the touch-sensitive delete key, deleting the last character of the series of characters from the text-input area and continuing to display a remainder of the series of characters in the text-input area; and
in response to a swipe gesture on the touch-sensitive delete key, deleting the remainder of the series of characters from the text-input area.

2. The method of claim 1, wherein, after deleting the remainder of the series of characters from the text-input area, the device continues to display in the text-input area a second series of characters, and the method further comprises:
in response to a new swipe gesture on the touch-sensitive delete key, deleting the second series of characters from the text-input area.

3. The method of claim 2, wherein:
the new swipe gesture is received within a predetermined amount of time after a lift-off of a contact associated with the swipe gesture, and
the deleting the second series of characters includes deleting the second series of characters at a same time.

4. The method of claim 3, wherein:
after deleting the second series of characters, the device continues to display a third series of characters in the text-input area, and
the method further comprises:
in response to an additional swipe gesture on the touch-sensitive delete key that is received after the predetermined amount of time from a lift-off of a contact associated with the new swipe gesture, deleting one character of the third series of characters from the text-input area before deleting a remainder of the third series of characters from the text-input area.

5. The method of claim 2, wherein, before deleting the second series of characters, the method comprises:
displaying a visual indicator around the second series of characters to provide an indication that the second series of characters would be deleted from the text-input area after a new swipe gesture on the touch-sensitive delete key.

6. The method of claim 1, further comprising:
in response to a press-and-hold gesture on the touch-sensitive delete key, deleting two or more separate series of characters from the text-input area, wherein the two or more separate series of characters are deleted from the text-input area at different points in time.

7. The method of claim 2, wherein the series of characters and the second series of characters were added to the text-input area based on a continuous-path gesture in which a continuous contact moves across multiple keys of a touch-sensitive keyboard.

8. The method of claim 2, wherein the series of characters and the second series of characters were added to the text-input area based on tap gestures over respective keys of a touch-sensitive keyboard.

9. The method of claim 1, wherein the touch-sensitive delete key is displayed on a touch-sensitive keyboard on the display.

10. The method of claim 1, wherein the touch-sensitive delete key is displayed on a touch-sensitive secondary display that is separate from the display of the electronic device.

11. An electronic device, comprising:
one or more processors;
a display;
a touch-sensitive delete key; and
memory storing one or more programs that are configured for execution by the one or more processors, the one or more programs including instructions for:
displaying a series of characters and a cursor after a last character of the series of characters in a text-input area on the display;
in response to a tap gesture on the touch-sensitive delete key, deleting the last character of the series of characters from the text-input area and continuing to display a remainder of the series of characters in the text-input area; and
in response to a swipe gesture on the touch-sensitive delete key, deleting the remainder of the series of characters from the text-input area.

12. A non-transitory computer-readable storage medium storing executable instructions that, when executed by one or more processors of an electronic device with a display and a touch-sensitive delete key, cause the electronic device to:
display a series of characters and a cursor after a last character of the series of characters in a text-input area on the display;
in response to a tap gesture on the touch-sensitive delete key, delete the last character of the series of characters from the text-input area and continuing to display a remainder of the series of characters in the text-input area; and
in response to a swipe gesture on the touch-sensitive delete key, delete the remainder of the series of characters from the text-input area.
